(19) United States
(12) Patent Application Publication
(10) Pub. No.: US 2004/0048036 A1
(43) Pub. Date: Mar. 11, 2004

(54) Floor mat for automobile

(75) Inventors: Sakae Nakasuji, Shiga (JP); Tatsuhiko Tsumura, Shiga (JP); Motofumi Kikuchi, Shiga (JP)

Correspondence Address: SUGHRUE MION, PLLC, 2100 PENNSYLVANIA AVENUE, N.W., WASHINGTON, DC, 20037, US

(73) Assignee: Japan Vilene Company, Ltd.

(21) Appl. No.: 10/660,692

(22) Filed: Sep. 12, 2003

Related U.S. Application Data
(63) Continuation-in-part of application No. 10/152,796, filed on May 23, 2002.

(30) Foreign Application Priority Data
May 24, 2001 (JP) 2001-156025
Sep. 13, 2002 (JP) 2002-268358

(51) Int. Cl. B32B 3/02; B32B 33/00

(52) U.S. Cl. 428/95; 428/156; 428/172

(57) ABSTRACT

A floor mat for an automobile consisting essentially of one or more porous material layers wherein a water-resistant pressure of the whole floor mat is 40 mmH₂O or more is disclosed. A floor mat for an automobile consisting essentially of two or more porous material layers, wherein at least one of the porous material layers is a mixture layer containing two or more materials including a material other than one or more materials forming a porous material layer adjacent to the mixture layer, and a permeability of the mixture layer is 0.1 to 10 mL/cm²/sec is disclosed.

### CROSS REFERENCE TO RELATED APPLICATION

This is a continuation-in-part application of U.S. patent application Ser. No. 10/152,796 filed on May 23, 2002.

### BACKGROUND OF THE INVENTION

1. Field of the Invention

The present invention relates to a floor mat for an automobile.

2. Description of the Related Art

A floor mat for an automobile is laid over a carpet floor in an automobile to prevent an adherence and staining of the carpet floor by dirt on shoes, such as soil, sand, mud, gravel, rainwater, or muddy water, or drinks spilled by a driver or a passenger.

As shown in FIG. 9, which is a schematic exploded sectional view, a conventional floor mat 30 for an automobile comprises an upper face layer 31 of a carpet or the like and a base layer 35 of a rubber, a thermoplastic elastomer or the like. The carpet upper face layer 31 comprises, for example, a pile layer 31a and a substrate layer 31b, and the base layer 35 supports the carpet upper face layer 31. In the above-mentioned floor mat 30, the base layer 35 provides durability, and projections from the surface of the base layer 35 provide a slip resistance.

The conventional floor mat 30 as above contains the base layer 35 and thus is very heavy. Therefore, when an automobile is driven with the conventional floor mats, an amount of fuel consumed is increased, and the environment is badly influenced.

Japanese Unexamined Patent Publication (Kokai) No. 2001-47926 discloses a lightweight floor mat for an automobile, that is, a mat mainly composed of a pile structure of a surface layer and a low density porous sound absorbing material layer stuck to the reverse side of the pile structure, and having a flexibility for fitting a shape of a carpet floor as a whole. Nevertheless, an object of the mat is to provide a sound absorbing property, and the mat is mainly composed of the porous sound absorbing material. Thus, the mat does not exhibit a required function as a floor mat for an automobile, i.e., a function to prevent a carpet floor from being stained by muddy water or the like, and therefore, is of no practical use.

In addition, a car voice navigation system is currently widely used, and thus a greater interest in silence inside an automobile is generated. As a method for improving silence inside an automobile, there may be mentioned two different methods. One is a method for improving a sound insulation property, which reduces sounds from the outside of an automobile, and the other is a method for improving a sound absorption property which reduces sounds transmitted in an automobile.

A conventional floor mat for an automobile prepared by laminating a thermoplastic elastomer or a rubber sheet with slip-resistant projections on the reverse side of a carpet exhibits an excellent sound insulation property, but a poor sound absorption property. Conversely, the above-mentioned floor mat for an automobile disclosed in Japanese Unexamined Patent Publication (Kokai) No. 2001-47926 is mainly composed of a pile structure and a sound absorbing material, and exhibits an excellent sound absorption property, but a poor sound insulation property.

### SUMMARY OF THE INVENTION

Of course, a floor mat for an automobile can be made lighter, by using a lightweight base layer of a porous material such as a foam instead of a heavy base layer such as a rubber, a thermoplastic elastomer or the like, and thus an amount of fuel used can be reduced. The inventors of the present invention engaged in intensive research to realize a saving of weight, while maintaining a most fundamental function required by a floor mat for an automobile, that is, a property of preventing a carpet floor from being stained by rainwater, muddy water, or spilled drinks. Nevertheless, this was very difficult.

As a result of the intensive research, the present inventors found that, when a floor mat satisfies a particular property, a lightweight floor mat for an automobile can be realized, while maintaining an excellent function to prevent a carpet floor from being stained. The present invention is based on the above findings.

Accordingly, the object of the present invention is to provide a lightweight floor mat for an automobile which can exhibit an excellent function of preventing a carpet floor from being stained.

Further, in conventional floor mats for an automobile, one of the sound insulation property and the sound absorption property was excellent, but there was no conventional floor mat for an automobile exhibiting both of these properties. A low permeability is necessary to improve the sound insulation property, and a high permeability is necessary to improve the sound absorption property. These properties are contrary to each other, and thus it was very difficult to make a floor mat for an automobile exhibiting both properties.

The present inventors found that, when a floor mat satisfies a particular property, a floor mat for an automobile which exhibits both an excellent sound insulation property and an excellent sound absorption property, and improves silence inside of an automobile, can be realized. The present invention is also based on the above findings.

Another object of the present invention is to provide a floor mat for an automobile exhibiting both an excellent sound insulation property and an excellent sound absorption property.

Other objects and advantages of the present invention will be apparent from the following description.

In accordance with the present invention, there is provided a floor mat for an automobile consisting essentially of one or more porous material layers wherein a water-resistant pressure of the whole floor mat is 40 mmH₂O or more (hereinafter sometimes referred to as the first floor mat for an automobile of the present invention). The floor mat for an automobile according to the present invention is weight-saving because it consists essentially of one or more porous material layers as above, and rainwater, muddy water, spilled drinks or the like are less likely to permeate the floor mat and stain the carpet floor, because the water-resistant pressure of the whole floor mat is 40 mmH₂O or more.

According to a preferred embodiment of the present invention, a permeability of the whole floor mat is 0.3 mL/cm²/sec or more. The floor mat having a permeability of 0.3 mL/cm²/sec or more exhibits a sound absorbing property, and when a carpet floor on which the present floor mat is laid in the automobile has a sound absorbing property, an excellent absorbing function is obtained. Further, the floor mat according to the present invention may contain a deodorant, an aromatic, an antimicrobial agent, a fungicide, or the like. In particular, the properties of a deodorant, an aromatic, an antimicrobial agent, a fungicide, or the like can be effectively exhibited when contained in the present floor mat having a permeability of 0.3 mL/cm²/sec or more.

According to a further preferred embodiment of the present invention, the porous material layer as an upper surface layer of the floor mat is a carpet layer. The floor mat having the carpet upper surface layer has an excellent decorative effect. When a permeability of the carpet upper surface layer alone is 2 mL/cm²/sec or more, permeable properties of other porous material layers located under the carpet upper surface layer can be effectively exhibited, and a souund absorbing property of the whole floor mat becomes excellent. When a carpet floor on which the present floor mat is laid in the automobile has a sound absorbing property, an excellent absorbing function is obtained. Further, when a deodorant, an aromatic, an antimicrobial agent, a fungicide, or the like is contained in the present floor mat having the carpet upper surface layer with a permeability of 2 mL/cm²/sec or more alone, their properties can be effectively exhibited.

According to a still further preferred embodiment of the present invention, a fine-fibers nonwoven fabric layer comprising fine fibers having a diameter of 10 μm or less is contained as the porous material layer of an intermediate layer and/or a reverse side layer. When the present floor mat comprising the fine-fibers nonwoven fabric layer is used, rainwater, muddy water, spilled drinks or the like can be effectively prevented from reaching the carpet floor in an automobile. Further, a sound absorbing property is enhanced with an interaction of the carpet floor. When the fine-fibers nonwoven fabric layer contains a resin, the structure thereof becomes denser. Therefore, rainwater, muddy water, spilled drinks or the like can be more effectively prevented from reaching the carpet floor, and a sound absorbing property is further enhanced.

According to a still further preferred embodiment of the present invention, a foam layer is contained as the porous material layer of an intermediate layer and/or a reverse side layer. The present floor mat containing the foam layer may exhibit various functions such as a cushioning property. When the floor mat has the foam layer as the reverse side layer, a slip-resistant property is obtained.

When the reverse side layer has a permeability of 0.3 to 20 mL/cm²/sec alone, a sound (particularly a treble sound of 2000 Hz or more) impinged from the reverse side of the floor mat can be reflected, to maintain a quiet ambience inside an automobile.

When an exposed surface of the foam layer as the reverse side layer has a concave-convex structure, the convex portions can bite into the carpet floor of the automobile to enhance a slip resistance of the floor mat.

In accordance with the present invention, there is also provided a slip-proof floor mat for an automobile comprising

(1) the floor mat according to the present invention and

(2) projected portions of slip-resistant resin having a slip resistance value of 0.6N or more, the projected portions being partially located on an exposed surface of a reverse side layer of the floor mat.

When the projected portions of the slip-resistant resin having a slip resistance value of 0.6N or more are partially located on the exposed surface of the reverse side layer of the floor mat, a slip-resistant property of the floor mat for an automobile is enhanced without affecting the weight-saving of the floor mat. An apparent permeability of the floor mat can be maintained even if the slip-resistant resins are partially located on the exposed surface, and therefore, the slip-proof floor mat exhibits an excellent absorbing function with an interaction of the carpet floor. Further, when a deodorant, an aromatic, or the like is contained in the present the slip-proof floor mat, their properties can be effectively exhibited. Furthermore, when the water-resistant pressure of the whole slip-proof floor mat is 40 mmH₂O or more, the carpet floor is less likely to be stained.

In accordance with the present invention, there is also provided a floor mat for an automobile consisting essentially of two or more porous material layers, wherein at least one of the porous material layers is a mixture layer containing two or more materials including a material other than one or more materials forming a porous material layer adjacent to the mixture layer, and a permeability of the mixture layer is 0.1 to 10 mL/cm²/sec (hereinafter sometimes referred to as the second floor mat for an automobile of the present invention). The floor mat for an automobile according to the present invention has the mixture layer having a permeability of 0.1 to 10 mL/cm²/sec, as the porous material layer, and thus exhibits both of an excellent sound insulation property and an excellent sound absorption property.

According to a preferred embodiment of the present invention, the porous material layer as an upper surface layer of the floor mat is a carpet layer. The floor mat having the carpet upper surface layer has an excellent decorative effect.

When the floor mat for an automobile of the present invention contains two or more porous material layers other than the carpet layer, a sufficient space between the upper surface layer and the mixture layer can be obtained. Such a structure is preferable, because an excellent sound absorbing property can be obtained at the upper surface side with respect to the mixture layer, and an excellent sound insulating property can be obtained at the reverse side with respect to the mixture layer, and thus both of the properties can be obtained.

When the floor mat for an automobile according to the present invention contains a porous material layer having a permeability of 15 mL/cm²/sec or more, as the porous material layers other than the carpet layer and located at the upper surface layer side with respect to the mixture layer having a permeability of 0.1 to 10 mL/cm²/sec, it can effectively absorb sounds in an automobile.

In the floor mat for an automobile according to the present invention, when a distance between the surface at the reverse side of the mixture layer having a permeability of 0.1 to 10 mL/cm²/sec and the surface at the reverse side of the floor mat is 0 to ⅔ of a thickness of the floor mat, excluding the carpet layer, the present floor mat can effectively absorb sounds in an automobile at the upper surface side with respect to the mixture layer, and can effectively insulate sounds from the outside of the automobile at the reverse side of the mixture layer.

In the floor mat for an automobile according to the present invention, when the materials forming the mixture layer having a permeability of 0.1 to 10 mL/cm²/sec are a foam resin and a material forming a porous material layer adjacent to the mixture layer, the adhesiveness between the mixture layer and the adjacent porous material layer is excellent and thus a peeling from each other rarely occurs.

### BRIEF DESCRIPTION OF DRAWINGS

FIG. 1 is a schematic sectional view of a dividable fiber which may be used to prepare the fine-fibers nonwoven fabric layer optionally contained in the present floor mat.

FIG. 2 is a schematic sectional view of another dividable fiber which may be used to prepare the fine-fibers nonwoven fabric layer optionally contained in the present floor mat.

FIG. 3 is a schematic sectional view of still another dividable fiber which may be used to prepare the fine-fibers nonwoven fabric layer optionally contained in the present floor mat.

FIG. 4 is a schematic sectional view of still another dividable fiber which may be used to prepare the fine-fibers nonwoven fabric layer optionally contained in the present floor mat.

FIG. 5 is a schematic sectional view of still another dividable fiber which may be used to prepare the fine-fibers nonwoven fabric layer optionally contained in the present floor mat.

FIG. 6 is a schematic exploded sectional view of one embodiment of the floor mat for an automobile according to the present invention, particularly the floor mats prepared in Examples 1 and 2, wherein the porous material layers in the floor mat are separated from each other.

FIG. 7 is a schematic exploded sectional view of another embodiment of the floor mat for an automobile according to the present invention, particularly the floor mat prepared in Example 3, wherein the porous material layers in the floor mat are separated from each other.

FIG. 8 is a schematic exploded sectional view of a still another embodiment of the floor mat for an automobile according to the present invention, particularly the floor mat prepared in Example 4, wherein the porous material layers in the floor mat are separated from each other.

FIG. 9 is a schematic exploded sectional view of the conventional floor mat for an automobile, particularly the floor mats prepared in Comparative Examples 1 and 2, wherein the layers in the floor mat are separated from each other.

FIG. 10 is a schematic exploded sectional view of another conventional floor mat for an automobile, particularly the floor mat prepared in Comparative Example 3, wherein the layers in the floor mat are separated from each other.

FIG. 11 is a graph showing a relationship of the absorption coefficient and frequency for the floor mat for an automobile according to the present invention and a conventional floor mat for an automobile.

FIG. 12 is a schematic sectional view of one embodiment of the floor mat for an automobile according to the present invention, particularly the floor mats prepared in Examples 7 and 8.

FIG. 13 is a graph showing a relationship of the sound transmission loss and frequency for the floor mats for an automobile according to the present invention and comparative floor mats for an automobile.

FIG. 14 is a graph showing a relationship of the sound absorption coefficient and frequency for the floor mats for an automobile according to the present invention and comparative floor mats for an automobile.

### DESCRIPTION OF THE PREFERRED ENBODIMENTS

[1] The First Floor Mat for an Automobile According to the Present Invention

The floor mat for an automobile according to the present invention consists essentially of one or more porous material layers, so that a saving of the weight of the floor mat is realized. The material used for the porous material layers of the floor mat for an automobile according to the present invention is not particularly limited so long as it is porous and a water-resistant pressure of the whole floor mat consisting essentially of one or more porous material layers is 40 mmH₂O or more. Examples of the porous material are a carpet, nonwoven fabric, woven fabric, knitted fabric, foam, breathable or permeable film, or microporous film, or crushed rubber laminate prepared by laminating crushed rubbers and adhering them by an adhesive.

Of the porous materials as above, the carpet has an excellent decorative effect, and can provide a comfortable driving effect and thus it can be preferably used as the porous material layer of an upper surface layer of the floor mat for an automobile. The carpet is not particularly limited, but may be for example, a tufted carpet, a needle-punched carpet, a hand-knotted carpet, a hooked rug, a wilton carpet, an axminster carpet, or the like.

When the carpet layer contains functional fibers such as deodorizing fibers, antimicrobial fibers, or fungicidal fibers and the carpet layer is located as the upper surface layer, or when one or more porous material layers containing the functional fibers are not located as the upper surface layer, but the floor mat has a permeability, the functions of the functional fibers can be exhibited. Further, when the floor mat has a permeability, the floor mat containing functional resins such as deodorizing resins, antimicrobial resins, or fungicidal resins in addtion to or instead of the functional fibers can exhibit the functional effect as above.

A permeability of the carpet layer alone which may be used as the porous material layer is preferably 2 mL/cm²/sec or more, more preferably 6 mL/cm²/sec or more.

The carpet which may be used as the porous material layer may be prepared by a conventional method.

In the present specification, the “upper surface layer” of the floor mat means a layer visible when laid over the carpet floor in an automobile.

The floor mat for an automobile according to the present invention may contain one or more fine-fibers nonwoven fabric layers as the porous material layer. When the present floor mat contains the fine-fibers nonwoven fabric layer containing the fine fibers having a diameter of 10 μm or less, as one of the porous material layers, the floor mat can effectively prevent rainwater, muddy water, spilled drinks or the like from reaching the carpet floor and enhance a sound absorbing property with an interaction of the carpet floor.

The finer fiber diameter of the fine fibers forming the fine-fibers nonwoven fabric layer can exhibit more excellent functions in the above properties. Therefore, the fiber diameter of the fine fiber is preferably 5 μm or less, more preferably 3 μm or less. The lower limit of the fiber diameter is not particularly limited, but about 0.1 μm is suitable.

The term “fiber diameter” as used herein with respect to a fiber having a circular cross-sectional shape means a diameter of the circle. For a fiber having a non-circular cross-sectional shape, a diameter of a circle having an area the same as that of the non-circular cross-sectional shape is regarded as a diameter.

The fine fiber may be formed by any resin components, for example, one or more components of a polyamide-based resin (such as nylon-6 or nylon-66), a polyester based resin (such as polyethylene terephthalate or polybutylene terephthalate), a polyolefin based resin (such as polyethylene or polypropylene), a polyvinylidene chloride based resin, or the like. Of the above resins, the polyamide-based resin (such as nylon-6 or nylon-66) is preferable, because a water repellency can be easily imparted to the fine-fibers nonwoven fabric containing the polyamide-based resin by a treatment, as mentioned below, to obtain the floor mat for an automobile having a water-resistant pressure of 40 mmH₂O or more. Further, when the fine-fibers nonwoven fabric layer consists essentially of the fine fibers of the polyolefin based resin, the floor mat having a water-resistant pressure of 40 mmH₂O or more can be easily obtained. Therefore, the polyolefin based resin is also preferable.

The fine-fibers nonwoven fabric used in the present floor mat for an automobile may contain two or more resins different from each other with respect to a resin composition and/or fiber diameter.

The fine fiber as mentioned above may be prepared by dividing dividable fibers by a physical or chemical action, or a melt blowing method. The physical action may be, for example, a fluid jet, such as a water jet, a calendaring, or a flat-pressing, and the chemical action may be, for example, a removal or swelling of one or more resin components. Of these actions, the physical action to divide the dividable fiber is preferable, because fine fibers having an excellent strength and a fine-fibers nonwoven fabric having a dense structure can be obtained.

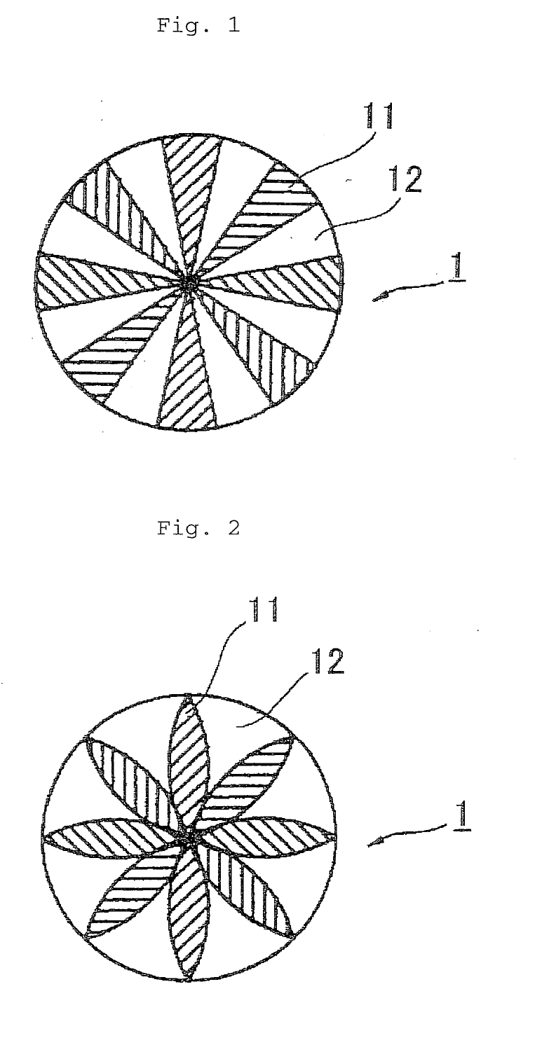

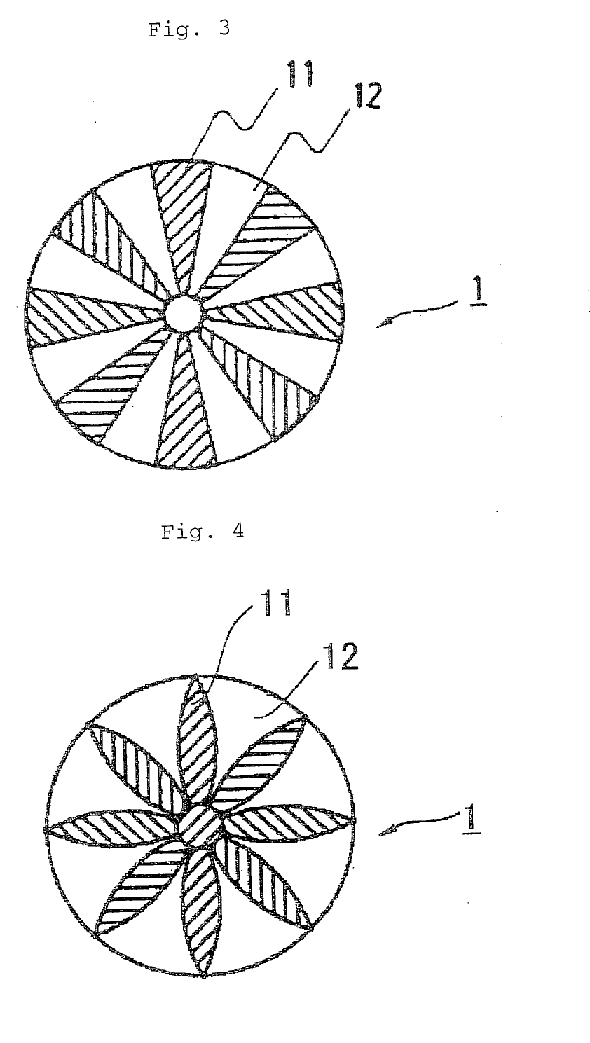

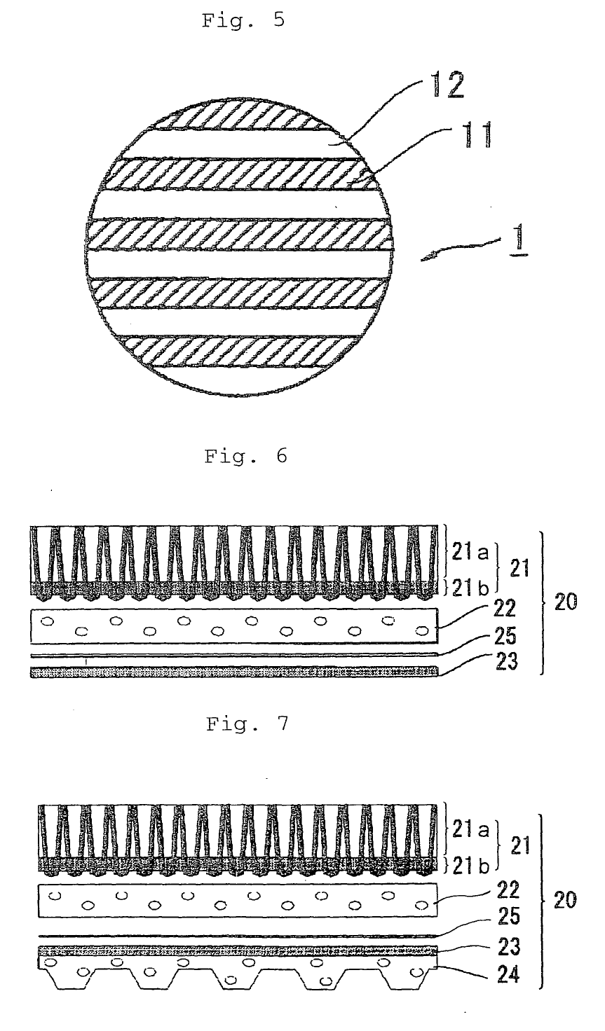

The dividable fiber by the physical or chemical action may be a conjugate fiber containing two or more resin components, for example, a dividable fiber 1 of an orange type conjugate fiber having a sectional view similar to that of an orange fruit (see FIGS. 1 to 4) or a dividable fiber 1 of a multiple bimetal type conjugate fiber having a sectional view similar to that of a multiple bimetal (see FIG. 5). As shown in FIGS. 1 to 5, a dividable fiber 1 contains at least two separated resin components 11, 12.

A fiber diameter of the dividable fiber is not particularly limited, so long as the dividable fiber can produce the fine fibers having the above-mentioned diameter. A fiber length of each of the dividable fiber and the fine fiber is not particularly limited, but the dividable fiber and the fine fiber may be a short fiber having a length of about 1 to 160 mm, or a long fiber having a longer length.

When an amount of the fine fibers is increased, the stain-preventing property and the sound absorbing property can be enhanced. Therefore, the fine fibers accounts for preferably 50 mass % or more, more preferably 80 mass % or more of the fine-fibers nonwoven fabric.

Fibers forming the fine-fibers nonwoven fabric other than the fine fibers may be, for example, a nylon based fiber, a vinylon based fiber, a vinylidene based fiber, a polyvinyl chloride based fiber, a polyester based fiber, an acryl based fiber, a polyolefin based fiber, a polyurethane based fiber, or an undivided dividable fiber, each having a fiber diameter of more than 10 μm. Further, the fine-fibers nonwoven fabric may contain functional fibers such as deodorizing fibers, heat-fusible fibers, or highly-crimping fibers.

The fine-fibers nonwoven fabric may be prepared by forming a fiber web containing dividable fibers as mentioned above by a dry-laid method, such as a carding method or an air-laying method, a spun-bonding method, or a wet-laid method, and then applying the physical or chemical action to the fiber web. If necessary, a heating treatment with or without partially or wholly applying a pressure may be carried out in addition to the physical or chemical action. When the fiber web is prepared by the melt-blowing method, the fine-fibers nonwoven fabric may be prepared without any further treatment, or by binding fibers to each other by a heat treatment with or without partially or wholly applying a pressure.

The fine-fibers nonwoven fabric may contain a resin to produce a denser structure. Therefore, very little rainwater, muddy water, spilled drinks or the like will permeate the fine-fibers nonwoven fabric containing the resin, and reach a carpet floor, and a sound absorbing property is further enhanced.

The resin which may be contained in the fine-fibers nonwoven fabric is not particularly limited, but for example, is a thermoplastic resin, such as isobutylene-maleic anhydride copolymer, acrylonitrile-styrene-acrylic rubber copolymer, acrylonitrile-ethylene-styrene copolymer, acrylonitrile-styrene copolymer, acrylonitrile-butadiene-styrene copolymer, styrene-butadiene copolymer, ethylene-vinyl acetate copolymer, ethylene-vinyl chloride-vinyl acetate copolymer, or a thermosetting resin, such as epoxy resin, xylene resin, phenol resin, polyimide resin, polyurethane resin, melamine resin, urea resin, or a rubber, such as styrene-butadiene rubber, butadiene rubber, isoprene rubber, nitrile-butadiene rubber, butyl rubber, ethylene-propylene rubber, ethylene-propylene dinene rubber, urethane rubber, silicone rubber. Of these resins, acrylonitrile-ethylene-styrene copolymer, or ethylene--vinyl acetate copolymer is preferable.

When the fine-fibers nonwoven fabric contains such a resin, a carpet floor is little stained, and a sound absorbing property is enhanced. However, if an amount of the resin contained in the fine-fibers nonwoven fabric becomes large, the floor mat for an automobile becomes heavy. Therefore, the amount of the resin is preferably 5 to 100 g/m², more preferably 5 to 20 g/m².

The resin as mentioned above can be applied to the fine-fibers nonwoven fabric by spraying or coating a resin solution or emulsion, or by dipping the fabric in the resin solution or emulsion.

An area density, that is, a mass per 1 m², of the fine-fibers nonwoven fabric layer (including the case where the fabric contains the resin as above) is preferably 60 to 200 g/m², more preferably 70 to 120 g/m², so as to realize a weight-saving of the floor mat for an automobile. A thickness of the fine-fibers nonwoven fabric layer (including the case where the fabric contains the resin as above) is preferably about 0.2 to 0.6 mm. The thickness is determined in accordance with the method defined in JIS B 7502, that is, a value obtained by measuring a sample upon application of a 5 N load by an outside micrometer. An apparent density of the fine-fibers nonwoven fabric layer (including the case where the fabric contains the resin as above) is preferably 0.1 to 1 g/cm³, more preferably 0.12 to 0.6 g/cm³. The apparent density is a value obtained by dividing an area density with a thickness.

The floor mat for an automobile according to the present invention may contain one or more bulky-nonwoven fabric layers as the porous material layer. When the bulky-nonwoven fabric is contained in the floor mat, a sound absorbing property is enhanced. Therefore, it is preferable to use the bulky-nonwoven fabric layer in addition to or instead of the fine-fibers nonwoven fabric layer. The term “bulky-nonwoven fabric layer” as used herein means a nonwoven fabric layer having a thickness of 1 mm or more, and the thickness is a value measured upon applying a 10 g/1 cm² load. The floor mat containing the bulky-nonwoven fabric layer having a greater thickness can enhibit a more excellent sound absorbing property, but the thickness of the bulky-nonwoven fabric layer is preferably 10 mm or less from a practical standpoint of view as a floor mat.

An area density of the bulky-nonwoven fabric layer is preferably 50 to 1000 g/m², more preferably 70 to 500 g/m², so that it can contribute to the weight-saving of the present floor mat for an automobile. An apparent density (a value obtained by dividing an area density with a thickness) of the bulky-nonwoven fabric layer is preferably 0.02 to 0.25 g/cm³, more preferably 0.035 to 0.17 g/cm³.

The bulky-nonwoven fabric may be prepared by, for example, (1) forming a fiber web by a dry-laid method and then needle-punching the fiber web, (2) forming a fiber web containing heat-fusible fibers by a dry-laid method, and then heating the fiber web without a pressure or under a slight pressure for adjusting a thickness to fuse the heat-fusible fibers, or (3) laminating melt-blown nonwoven fabrics containing fibers having a fiber diameter of 6.6 dtex or more.

The floor mat for an automobile according to the present invention may contain one or more foam layers as the porous material layer. When the foam layer is contained, various functions such as a cushioning property may be obtained. The foam used as the foam layer may be a closed-cell structure or an open-cell structure. When the open-cell foam layer is used, an excellent sound absorbing property is obtained, and further, functions of a deodorant or perfume which may be contained in the floor mat for an automobile are not affected.

A resin forming the foam layer is not particularly limited, but for example, a urethane resin, acrylic resin, styrene-butadiene copolymer resin, styrene-butadiene rubber, nitrile-butadiene rubber, isoprene rubber or the like.

A foaming magnification, i.e, a ratio (b/a) of a density before expansion (b) to a density after expansion (a), of the foam is not particularly limited, but is preferably 1.2 to 20 fold, more preferably 2 to 10 fold. This is because when the foaming magnification is large, a cushioning property is enhanced when heavily trod upon, whereas a thickness of the form is liable to decrease by deterioration.

An area density of the foam layer is preferably 200 to 1000 g/m², more preferably 300 to 500 g/m², so that it can contribute to the weight-saving of the present floor mat for an automobile. A thickness of the foam layer is preferably about 1 to 7 mm. When the foam layer has a concave-convex structure as mentioned below, the thickness means a thickness of a convex portion. An apparent density (a value obtained by dividing an area density with a thickness) of the foam layer is preferably 0.03 to 1 g/cm³, more preferably 0.04 to 0.5 g/cm³.

The foam used as the foam layer may be prepared by a conventional method.

The foam layer may be located as any layer in the floor mat for an automobile according to the present invention, i.e, as an upper surface layer, an intermediate layer or a reverse side layer. When the floor mat for an automobile contains the carpet layer and the fine-fibers nonwoven fabric layer or bulky nonwoven fabric as above, the foam layer is preferably located between the carpet layer and the fine-fibers nonwoven fabric layer or bulky nonwoven fabric. Such a structure can enhance an adhesiveness of the carpet layer and the fine-fibers nonwoven fabric layer or bulky nonwoven fabric, and thus, may avoid a peeling from each other. It is also preferable to use the foam layer as a reverse side layer in the present floor mat for an automobile, because a slipping of the floor mat for an automobile can be prevented. When the foam layer is used as the reverse side layer of the present floor mat for an automobile, the foam layer preferably possesses a concave-convex structure on an exposed surface (reverse side) so that a slipping of the floor mat for an automobile can be more effectively prevented.

The term “reverse side layer” as used herein means a layer directly in contact with a carpet floor of an automobile.

The floor mat for an automobile according to the present invention consists essentially of one or more porous material layers as above, and thus is lightweight. Preferred combinations of plural porous material layers are as follows (the following order is from the upper surface layer to the reverse side layer):

(1) the carpet layer—the foam layer—the fine-fibers nonwoven fabric layer,

(2) the carpet layer—the foam layer—the bulky nonwoven fabric layer,

(3) the carpet layer—the foam layer—the fine-fibers nonwoven fabric layer—the foam layer,

(4) the carpet layer—the foam layer—the bulky nonwoven fabric layer—the foam layer,

(5) the carpet layer—the fine-fibers nonwoven fabric layer—the foam layer, and

(6) the carpet layer—the fine-fibers nonwoven fabric layer.

The combination is not limited to the above-mentioned embodiments.

The above-mentioned floor mat for an automobile according to the presenet invention may be used to produce a slip-proof floor mat for an automobile to which the present invention also relates. The present slip-proof floor mat for an automobile may be produced by forming projected portions of a slip-resistant resin having a slip resistance value of 0.6 N or more, preferably 0.8 N or more, more preferably 1.2 N or more, on an exposed surface of the reverse side layer of the above-mentioned floor mat for an automobile according to the presenet invention. The projected portions are partially located on the exposed surface of the reverse side layer of the floor mat. Thus, the present slip-proof floor mat for an automobile has a partially-located-resins layer on the reverse side, and can enhance the property of preventing the slippage. It is preferable that a water-resistant pressure of the whole slip-proof floor mat is 40 mmH₂O or more.

A shape formed by the projected portions or the partially-located-resins, on the whole reverse side surface, is not particularly limited. For example, the projected resins are located in a lattice-like shape or a grid-like shape, or around a peripheral portions of the reverse side layer, dispersed as dots, or forms strips.

The “slip resistance value” means a value obtained in accordance with the following procedures:

(1) A resin sheet sample (140 mm×100 mm) having a smooth surface without any mechanical structure for preventing slippage is prepared from a resin to be examined.

(2) Fiber webs (area density=200 g/m²) are prepared from polyethylene terephthalate fibers (fineness=6.6 dtex; fiber length=74 mm; cross-sectional shape of fiber=circle; crimp number=10 to 13/inch) by a dry carding machine, and then crossed in a lengthwise direction of the fiber webs by a cross-layer (sharp angle of the fiber webs to the lengthwise direction of the crossed-laid fiber web=20°) to obtain a crossed-laid fiber web. Thereafter, the resulting crossed-laid fiber web is treated with a needle-punching at a needle density of 250 needles/cm² only from one side of the fiber web to obtain a needle-punched nonwoven fabric.

(3) The resin sheet sample is mounted on the needle-punched nonwoven fabric by bringing it into contact with a surface having raised fibers. The raised-fibers surface is opposite to the surface treated by inserting the needles. Subsequently, a load of 100 g is mounted on the resin sheet sample, and the resin sheet sample is slid at a speed of 100 mm/minute in a lengthwise direction of the resin sheet sample to measure a force at a maximum point of a slip resistance value.

(4) The above procedures are repeated five times, and an average of the resulting values is taken as a slip resistance value.

An example of the slip-resistant resin is a thermoplastic resin, such as isobutylene maleic anhydride copolymer, acrylonitrile-styrene-acrylic rubber copolymer, acrylonitrile-ethylene-styrene copolymer, acrylonitrile-styrene copolymer, acrylonitrile-butadiene-styrene copolymer, styrene-butadiene copolymer, ethylene-vinyl acetate copolymer, ethylene-vinyl chloride-vinyl acetate copolymer, or a rubber, such as styrene-butadiene rubber, butadiene rubber, isoprene rubber, nitrile-butadiene rubber, butyl rubber, urethane rubber, ethylene-propylene rubber, ethylene-propylene-diene- rubber, silicone rubber or the like.

The slip-resistant resin can be applied by, for example,

(1) a method wherein a thickened resin emulsion is dotted by a galvanized cylinder or the like,

(2) a processing method by a hot-melt applicator,

(3) an injection method from an injection nozzle, or

(4) a method wherein the slip-resistant resin is applied on desired portions of the surface of the reverse side porous material layer and then hot-pressed.

In the present floor mat for an automobile or the present slip-proof floor mat for an automobile, a peripheral portion is preferably covered with a resin so that the shape of the present floor mat for an automobile or the present slip-proof floor mat for an automobile can be maintained when laid over the carpet floor in the automobile even at an elevated temperature in midsummer. Further, the peripheral portion of the floor mat or the slip-proof floor mat for an automobile can be shaped by covering it with the resin so that the shape of the floor mat or the slip-proof floor mat for an automobile can be fitted to that of the floor of the automobile. Therefore, the floor mat or the slip-proof floor mat for an automobile may be unified with the floor, and the decorativeness thereof can be enhanced.

The resin which may be used for covering the peripheral portion is not particularly limited, so long as it may maintain the shape of the floor mat or the slip-proof floor mat for an automobile, but for example, is a thermoplastic resin, such as isobytylene maleic anhydride copolymer, acrylonitrile-styrene-acrylic rubber copolymer, acrylonitrile-ethylene-styrene copolymer, acrylonitrile-styrene copolymer, acrylonitrile-butadiene-styrene copolymer, styrene-butadiene copolymer, ethylene-vinyl acetate copolymer, or ethylene-vinyl chloride-vinyl acetate copolymer, a thermosetting resin, such as epoxy resin, xylene resin, phenol resin, polyimide resin, polyurethane resin, melamine resin, or urea resin, or a rubber, such as styrene-butadiene rubber, butadiene rubber, isoprene rubber, nitrile-butadiene rubber, butyl rubber, urethane rubber, ethylene-propylene rubber, ethylene-propylene-diene rubber, or silicone rubber.

The peripheral portion of floor mat or the slip-proof floor mat for an automobile can be covered with the resin by, for example, a heat-press molding, a cold-press molding after preheating, a stamping molding by a melt resin extrusion, an injection molding, or the like.

The floor mat for an automobile according to the present invention consists essentially of one or more porous material layers as above. Nevertheless, it has an excellent water-resistance, because the water-resistant pressure of the whole floor mat is 40 mmH₂O or more. Therefore, rainwater, muddy water, spilled drinks or the like are less likely to permeate the floor mat and stain the carpet floor. The water-resistant pressure of the whole slip-proof mat for an automobile according to the present invention is also preferably 40 mmH₂O or more. The water-resistant pressure of the present floor mat for an automobile or the present slip-proof floor mat for an automobile is preferable 80 mmH₂O or more, more preferably 200 mmH₂O or more.

The term “water-resistant pressure” as used herein means a value measured at a time when water is leaked from 3 or more portions upon raising a water level at a speed of 10 cm±0.5 cm/min by a leveling apparatus in accordance with an A method (low hydraulic pressure), in JIS L 1092:1998 6.1, a test for a degree of water-resistance, a method of a static hydraulic pressure.

The required water-resistant pressure may be imparted to the present floor mat for an automobile by, for example,

(1) applying a water-repellant such as a fluoride water-repellant, or silicone-based water-repellant, or a material having a high hydrophobic property, such as a mineral oil or an aliphatic alcohol, to a reverse side of the carpet layer (which usually contains a primary substrate on the reverse side), the fine-fibers nonwoven fabric layer, or the foam layer,

(2) using the foam layer having the closed-cell structure,

(3) applying polyolefin powder to a reverse side of the carpet layer (which usually contains a primary substrate on the reverse side), the fine-fibers nonwoven fabric layer, or the foam layer,

(4) using a fiber sheet (such as a fine-fibers nonwoven fabric, woven fabric, or knitted fabric) consisting essentially of fibers having a surface consisting essentially of a polyolefin based resin, as the porous material layer, or

(5) using a microporous film as the porous material layer.

A combination of one or more of the above means (1) to (5) may be used.

When the floor mat for an automobile according to the present invention has a permeability of 0.3 mL/cm²/sec or more, it exhibits a function as a sound absorber, and an excellent absorbing function is obtained with an interaction of the carpet floor. Further, when functional fibers such as deodorant fibers, or functional resins such as deodorant resins or perfuming resins are contained in the floor mat for an automobile according to the present invention, their functions can be effectively exhibited. The permeability of the floor mat or the slip-proof floor mat for an automobile according to the present invention is preferably 2 mL/cm²/sec or more, more preferably 3 mL/cm²/sec or more. The upper limit of the permeability is not particularly limited, but is preferably about 60 mL/cm²/sec, more preferably 10 mL/cm²/sec.

The term “permeability” as used herein means a value obtained in accordance with JIS L 1096:1999 8.27.1, an A method, Frazier method.

It is believed that the permeability of the floor mat as a whole is dependent upon the lowest permeability of the porous material layers, such as the carpet layer, the fine-fibers nonwoven fabric layer, or the foam layer, in the whole floor mat. Therefore, the floor mat having the required permeability may be obtained by selecting suitable porous material layers.

When the carpet layer alone has a permeability of 2 mL/cm²/sec or more, the permeable properties of the porous material layers (such as the fine-fibers nonwoven fabric layer, or the foam layer) located under the carpet layer can be effectively utilized, and an excellent sound absorbing property can be obtained. The permeability of the carpet upper surface layer alone is preferably 4 mL/cm²/sec or more, more preferably 6 mL/cm²/sec or more, most preferably 7 mL/cm²/sec or more. Further, when the carpet layer alone has a permeability of 2 mL/cm²/sec or more, an excellent absorbing function is obtained with an interaction of the carpet floor. Further, when functional fibers such as deodorant fibers, or functional resins such as deodorant resins or perfuming resins are contained in the floor mat containing the carpet layer as mentioned above, their functions can be effectively exhibited.

When the reverse side layer alone has a permeability of 0.3 to 40 mL/cm²/sec, a sound (particularly a treble sound of 2000 Hz or more), that is, a noise outside an automobile, impinged from the reverse side of the floor mat can be reflected to maintain a quiet ambience inside an automobile. The permeability of the foam layer is more preferably 0.3 to 10 mL/cm²/sec.

When an exposed surface of the reverse side layer has a concave-convex structure, the convex portions can bite into the carpet floor of the automobile to enhance a slip resistance of the floor mat.

In the floor mat for an automobile according to the present invention, layers other than the carpet layer are composed of the porous material. Therefore, the present floor mat is lightweight, in comparison with a conventional floor mat comprising a base layer of a rubber, a thermoplastic elastomer or the like. More particularly, a total area density of the layers other than the carpet layer in the present floor mat for an automobile ranges from about 400 to about 1350 g/m², whereas the area density of the back layer of a rubber, a thermoplastic elastomer or the like in a conventional floor mat ranges from about 1700 to about 2400 g/m².

A process for producing the floor mat for an automobile according to the present invention is not particularly limited, but the present floor mat containing two or more porous material layers may be produced by, for example, preparing porous materials necessary for forming the porous material layers consitituing the present floor mat, and then,

(1) inserting a fusible porous sheet (such as a nonwoven fabric or a net) which can be fused at a temperature not affecting the properties of the porous material layers for the present floor mat, between each of the porous material layers, and integrating the porous material layers by heating to a fusing temperature of the fusible porous sheet,

(2) applying hot-melt resins between each of the porous material layers, and applying a pressure to integrate the layers, or

(3) fusing fusible resin constituting one or more porous material layers to integrate the layers by fusion.

When the peripheral portion of the present floor mat or the present slip-proof floor mat for an automobile is unsightly, or when the present floor mat or the present slip-proof floor mat for an automobile contains a fiber sheet layer and thus the fibers may drop out of the floor mat, it is preferable that the peripheral portion is covered with threads by a serging process, or by a taping process, or the peripheral portion is heat-fused, or covered with the resin as mentioned above.

When the projected portions of the slip-resistant resins are located on the exposed surface of the reverse side layer of the floor mat, the above-mentioned methods may be used. The application of the projected portions of the slip-resistant resins can be carried out before or after the laminating of the porous material layers.

Particular embodiments of the floor mat or the slip-proof floor mat for an automobile according to the present invention will be explained hereinafter, referring to FIGS. 6 to 8 which is a schematic exploded sectional view of each embodiment, respectively.

The floor mat 20 as shown in FIG. 6 contains (1) the carpet layer 21 containing a pile layer 21a and a substrate layer 21b, as the porous material layer of the upper surface layer, (2) the fine-fibers nonwoven fabric layer 23 containing the fine fibers having a diameter of 10 μm or less and impregnated with resins, as the porous material layer of the reverse side layer, and (3) the foam layer 22 between the carpet layer 21 and the fine-fibers nonwoven fabric layer 23. The carpet layer 21 and the foam layer 22 can be adhered to each other by coating a foamed latex on the carpet and drying the latex. The foam layer 22 and the fine-fibers nonwoven fabric layer 23 can be adhered to each other, via a hot-melt adhesive sheet 25. The floor mat 20 has an excellent decorative function, because it contains the carpet layer 21. The floor mat 20 can effectively prevent rainwater, muddy water, spilled drinks or the like from reaching the carpet floor, and a sound absorbing property is enhanced with an interaction of the carpet floor, because it contains the fine-fibers nonwoven fabric layer 23 having a dense structure. The floor mat 20 has a cushioning property provided from the foam layer 22 located between the carpet layer 21 and the fine-fibers nonwoven fabric layer 23. Further, the foam layer 22 can relieve an influence of the concave-convex structure of substrate layer 21b on the reverse side of the carpet layer 21 so that the carpet layer 21 can be tightly adhered to the fine-fibers nonwoven fabric layer 23. Therefore, a peeling of the carpet layer 21 or the fine-fibers nonwoven fabric layer 23 rarely occurs.

The floor mat 20 as shown in FIG. 7 further contains as the porous material layer, the foam layer 24 having the concave-convex structure on the exposed surface of the reverse side layer. The structure and the producing process of the floor mat 20 as shown in FIG. 7 are the same as those of the floor mat 20 as shown in FIG. 6, except that the foam layer 24 is adhered to the fine-fibers nonwoven fabric layer 23 by coating a foamed latex on the fine-fibers nonwoven fabric layer 23 and drying the latex. In the floor mat 20 as shown in FIG. 7, the reverse side layer is the foam layer 24 having the concave-convex structure on the exposed surface, and therefore, the floor mat 20 can be effectively prevented from slipping.

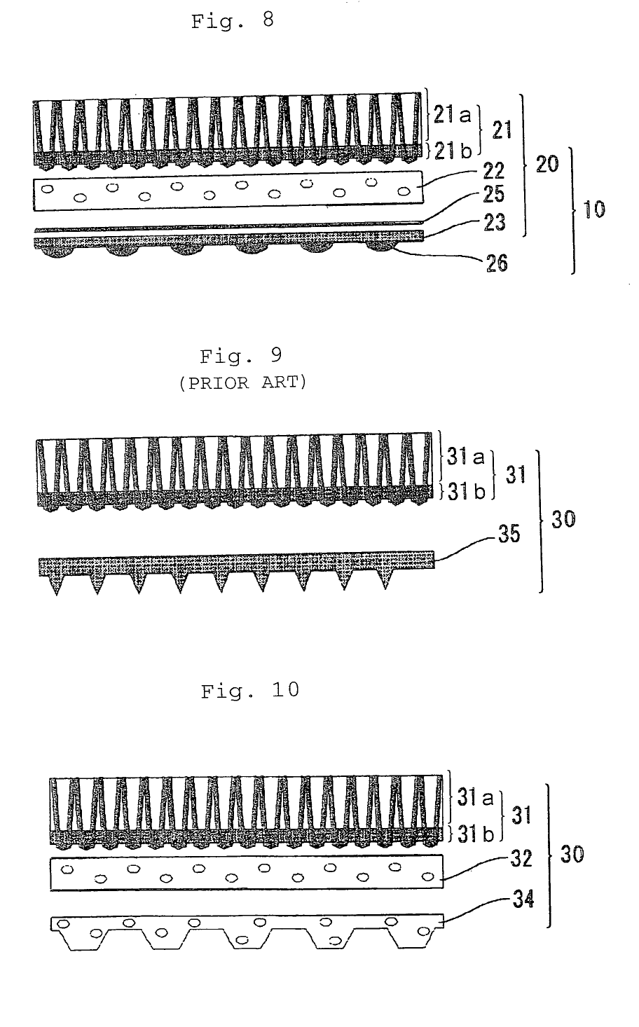

FIG. 8 illustrates the slip-proof floor mat 10 containing slip-resistant resins 26 partially located on the exposed surface of the fine-fibers nonwoven fabric layer 23 as the reverse side layer of the floor mat 20 as shown in FIG. 6. Therefore, the slip-proof floor mat 10 as shown in FIG. 8 can be effectively prevented from slipping because of the slip-resistant resins 26.

As mentioned, the floor mat or the slip-proof floor mat according to the present invention is laid over a carpet floor in an automobile. When the carpet floor on which the present floor mat or the present slip-proof floor mat is laid in the automobile has a sound absorbing property, an excellent absorbing function is obtained with an interaction of the carpet floor. For example, the floor mat or the slip-proof floor mat according to the present invention may be preferably laid over a carpet floor as disclosed in WO98/18657, that is, a carpet floor comprising a porous cushioning layer having a concave-convex structure capable of partially forming an air layer, a lightweight rigid layer containing micropores and having a total resistance of 500 to 2500 Nsm⁻³ to air, an area density of 300 to 2000 g/m², and rigidity of 0.005 to 10.5 Nm, and a carpet layer, and located so that the concave-convex structure of the cushioning layer is brought into direct contact with the automobile body. A lightweight and excellent sound-absorbing automobile can be provided by the above combination.

The floor mat for an automobile according to the present invention consists essentially of one or more porous material layers wherein a water-resistant pressure of the whole floor mat is 40 mmH₂O or more.

As above, the present floor mat for an automobile is weight-saving because it consists essentially of one or more porous material layers, and rainwater, muddy water, spilled drinks or the like are less likely to permeate the floor mat and stain the carpet floor, because the water-resistant pressure of the whole floor mat is 40 mmH₂O or more.

When the whole floor mat for an automobile according to the present invention has a permeability of 0.3 mL/cm²/sec or more, it exhibits a sound absorbing property. Further, when a carpet floor on which the present floor mat is laid in the automobile has a sound absorbing property, an excellent absorbing function is obtained. Further, the floor mat according to the present invention may contain a deodorant, an aromatic, an antimicrobial agent, a fungicide, or the like. In particular, a deodorant, an aromatic, an antimicrobial agent, a fungicide, or the like can effectively exhibit their properties when contained in the present floor mat having a permeability of 0.3 mL/cm²/sec or more.

When the floor mat for an automobile according to the present invention has the carpet layer as the porous material layer of an upper surface layer, it has an excellent decorative effect. When a permeability of the carpet upper surface layer alone is 2 mL/cm²/sec or more, permeable properties of other porous material layers located under the carpet upper surface layer can be effectively exhibited, and a souund absorbing property of the whole floor mat becomes excellent. When a carpet floor on which the present floor mat is laid in the automobile has a sound absorbing property, an excellent absorbing function is obtained. Further, when a deodorant, an aromatic, an antimicrobial agent, a fungicide, or the like is contained in the present floor mat having the carpet upper surface layer with a permeability of 2 mL/cm²/sec or more alone, their properties can be effectively exhibited.

When the floor mat for an automobile according to the present invention contains the fine-fibers nonwoven fabric layer comprising fine fibers having a diameter of 10 μm or less is contained as the porous material layer of an intermediate layer and/or a reverse side layer, rainwater, muddy water, spilled drinks or the like can be effectively prevented from reaching the carpet floor in an automobile. Further, a sound absorbing property is enhanced with an interaction of the carpet floor. When the fine-fibers nonwoven fabric layer contains a resin, the structure thereof becomes denser. Therefore, rainwater, muddy water, spilled drinks or the like can be more effectively prevented from reaching the carpet floor, and a sound absorbing property is further enhanced.

When the floor mat for an automobile according to the present invention contains the foam layer as the porous material layer of an intermediate layer and/or a reverse side layer, it may exhibit various functions such as a cushioning property. When the floor mat has the foam layer as the reverse side layer, a slip-resistant property is obtained.

When the reverse side layer in the floor mat for an automobile according to the present invention has a permeability of 0.3 to 20 mL/cm²/sec alone, a sound (particularly a treble sound of 2000 Hz or more) impinged from the reverse side of the floor mat can be reflected, to maintain a quiet ambience inside an automobile.

When an exposed surface of the foam layer as the reverse side layer in the floor mat for an automobile according to the present invention has a concave-convex structure, the convex portions can bite into the carpet floor of the automobile to enhance a slip resistance of the floor mat.

Further, the slip-proof floor mat for an automobile according to the present invention comprises projected portions of the slip-resistant resin having a slip resistance value of 0.6N or more, partially located on the exposed surface of the reverse side layer of the above-memtioned present floor mat.

When the projected portions of the slip-resistant resin having a slip resistance value of 0.6N or more are partially located on the exposed surface of the reverse side layer of the floor mat, a slip-resistant property of the floor mat for an automobile is enhanced without affecting the weight-saving of the floor mat. An apparent permeability of the floor mat can be maintained even if the slip-resistant resins are partially located on the exposed surface, and therefore, the slip-proof floor mat exhibits an excellent absorbing function with an interaction of the carpet floor. Further, when a deodorant, an aromatic, or the like is contained in the present slip-proof floor mat, their properties can be effectively exhibited. Furthermore, when the water-resistant pressure of the whole slip-proof floor mat is 40 mmH₂O or more, the carpet floor is less likely to be stained.

[2] The Second Floor Mat for an Automobile According to the Present Invention

The floor mat for an automobile according to the present invention consists essentially of two or more porous material layers, so that a sound absorption property is not inhibited. The material used for the porous material layers of the floor mat for an automobile according to the present invention is not particularly limited, so long as it is porous. As the porous material, there may be mentioned, for example, a carpet, nonwoven fabric, woven fabric, knitted fabric, foam, breathable or permeable film, or microporous film, or crushed rubber laminate prepared by laminating crushed rubbers and adhering them by an adhesive. The floor mat for an automobile according to the present invention may contain one or more components formed by one or more materials other than the porous material, so long as a sound absorbing property or a sound insulating property (particularly a sound absorption property) of the floor mat is not affected. As the component, there may be mentioned, for example, slip-resistant projections, a tape covering the peripheral portion of the floor mat, or the like.

Of the porous materials as above, the carpet has an excellent decorative effect, and can provide a comfortable driving effect and thus it can be preferably used as the porous material layer of an upper surface layer of the floor mat for an automobile. The carpet is not particularly limited, but may be for example, a tufted carpet, a needle-punched carpet, a hand-knotted carpet, a hooked rug, a wilton carpet, an axminster carpet, or the like.

When the carpet layer contains functional fibers such as deodorizing fibers, antimicrobial fibers, or fungicidal fibers and the carpet layer is located as the upper surface layer, the functions of the functional fibers can be exhibited.

Further, when one or more porous material layers containing the functional fibers as above are not located as the upper surface layer, the functions of the functional fibers can be also exhibited, because the floor mat for an automobile according to the present invention consists essentially of porous material layers.

Furthermore, when the floor mat contains functional resins such as deodorizing resins, antimicrobial resins, or fungicidal resins in addtion to or instead of the functional fibers, it can exhibit the functional effect as above.

A permeability (measured by a Frazier method defined in JIS L 1096) of the carpet layer alone which may be used as the porous material layer is preferably 10 mL/cm²/sec or more, more preferably 15 mL/cm²/sec or more, most preferably 20 mL/cm²/sec or more, so that a sound absorbing function of a porous material layer located nearer to the reverse side of the floor mat than the carpet layer can be utilized, functional effects of each functional material forming the porous material layer located nearer to the reverse side of the floor mat than the carpet layer can be exhibited, or an excellent sound absorbing function is obtained with an interaction of the carpet floor. The upper limit of the permeability of the carpet layer alone is not particularly limited, so long as the form of the carpet layer can be maintained.

The carpet which may be used as the porous material layer may be prepared by a conventional method.

In the present specification, the “upper surface layer” of the floor mat means a layer visible when laid over the carpet floor in an automobile.

The floor mat for an automobile according to the present invention may contain one or more fibers layer, as the porous material layer. The fibers layer is not particularly limited, but may be, for example, a woven fabric, knitted fabric, nonwoven fabric or the like.

Fibers forming the fibers layer are not particularly limited, but there may be mentioned, for example, a nylon based fiber, a vinylon based fiber, a vinylidene based fiber, a polyvinyl chloride based fiber, a polyester based fiber, an acryl based fiber, a polyolefin based fiber, a polyurethane based fiber, a glass fiber, or the like. The fibers layer may be formed by one or more of the above fibers.

More particularly, the floor mat for an automobile according to the present invention may contain one or more fine-fibers nonwoven fabric layers containing fine fibers having a diameter of 10 μm or less as the fibers layer. The permeability (measured by a Frazier method defined in JIS L 1096) of the fine-fibers nonwoven fabric is generally 10 to 50 mL/cm²/sec and similar to that of the mixture layer. Therefore, the fine-fibers nonwoven fabric may be used as a material forming the mixure layer, and the mixture layer having a permeability of 0.1 to 10 mL/cm²/sec may be formed together with the second material such as a resin.

Further, the floor mat for an automobile according to the present invention may contain one or more woven fabric layers such as a flat weave fabric or twill fabric formed by split yarn and/or tape yarn as the fibers layer. Permeable areas in the woven fabric are limited to areas surrounded by warps and wefts, and the permeability of the woven fabric can be reduced. Therefore, the woven fabric may be used as a material forming the mixure layer, and the mixture layer having a permeability of 0.1 to 10 mL/cm²/sec may be formed together with the second material such as a resin.

Furthermore, the floor mat for an automobile according to the present invention may contain one or more bulky-nonwoven fabric layers as the fibers layer. When the bulky-nonwoven fabric is contained and located nearer to the upper surface layer of the floor mat than the mixture layer, a sufficient space between the upper surface of the floor mat and the mixture layer can be obtained, and thus a sound absorbing function may be improved. The bulky-nonwoven fabric may be used as a material forming the mixure layer, and the mixture layer having a permeability of 0.1 to 10 mL/cm²/sec may be formed together with the second material such as resins.

The term “bulky-nonwoven fabric layer” as used herein means a nonwoven fabric layer having a thickness of 1 mm or more, and the thickness is a value measured upon applying a 10 g/1 cm² load. The floor mat containing the bulky-nonwoven fabric layer having a greater thickness can enhibit a more excellent sound absorbing property, but the thickness of the bulky-nonwoven fabric layer is preferably 15 mm or less from a practical standpoint of view as a floor mat.

A mass per unit area of the bulky-nonwoven fabric layer is preferably 50 to 1500 g/m², more preferably 70 to 1000 g/m², so that it can contribute to the weight-saving of the present floor mat for an automobile. An apparent density (a value obtained by dividing a mass per unit area with a thickness) of the bulky-nonwoven fabric layer is preferably 0.02 to 0.3 g/cm³, more preferably 0.035 to 0.25 g/cm³.

The bulky-nonwoven fabric may be prepared by, for example, (1) forming a fiber web by a dry-laid method and then needle-punching the fiber web, (2) forming a fiber web containing heat-fusible fibers by a dry-laid method, and then heating the fiber web without a pressure or under a slight pressure for adjusting a thickness to fuse the heat-fusible fibers, or (3) laminating melt-blown nonwoven fabrics containing fibers having a fiber diameter of 6.6 dtex or more.

As fibers layers other than the above fine-fibers nonwoven fabric layer, woven fabric layers such as a flat weave fabric or twill fabric formed by split yarn and/or tape yarn, or bulky-nonwoven fabric layer, there may be mentioned, for example, a fused nonwoven fabric, an entangled nonwoven fabric obtained by a water jet, a spun-bonded nonwoven fabric, a melt-blown nonwoven fabric, a reclaimed fiber felt, or the like.

The floor mat for an automobile according to the present invention may contain one or more foam layers, as the porous material layer composed of a resin. When the foam layer is contained, various functions such as a cushioning property may be added to the floor mat. The foam used as the foam layer is preferably an open-cell structure, so that the sound absorbing property is not reduced. When the foam layer is an open-cell structure, the functions of functional substances such as a deodorant, an aromatic, an antimicrobial agent, or a fungicidal agent which may be contained in the floor mat for an automobile are not affected.

A resin forming the foam layer is not particularly limited, but there may be mentioned, for example, a urethane resin, an acrylic resin, a styrene-butadiene copolymer resin, a styrene-butadiene rubber, a nitrile-butadiene rubber, an isoprene rubber, a nitrile rubber, a natural rubber, or the like. The above resins or rubbers may be used alone or in combination thereof.

A foaming magnification, i.e, a ratio (b/a) of a density before expansion (b) to a density after expansion (a), of the foam forming the foam layer is not particularly limited, but is preferably 1.2 to 20 fold, more preferably 2 to 10 fold. This is because when the foaming magnification is large, a cushioning property is enhanced when trod upon, whereas a thickness of the form is liable to decrease by deterioration.

A mass per unit area of the foam layer is preferably 200 to 1000 g/m², more preferably 300 to 800 g/m², so that it can contribute to the weight-saving of the present floor mat for an automobile. A thickness of the foam layer is preferably about 1 to 7 mm. When the foam layer has a concave-convex structure, the thickness means a thickness of a convex portion. An apparent density (a value obtained by dividing an area density with a thickness) of the foam layer is preferably 0.03 to 1 g/cm³, more preferably 0.04 to 0.5 g/cm³.

The foam used as the foam layer may be prepared by a conventional method.

The foam layer may be located as any layer in the floor mat for an automobile according to the present invention. When the floor mat for an automobile contains the carpet layer and the fibers layer as above, the foam layer is preferably located between the carpet layer and the fibers layer. Such a structure can enhance an adhesiveness of the carpet layer and the fibers layer, and thus, may avoid a peeling from each other when using. It is also preferable to use the foam layer as a reverse side layer in the present floor mat for an automobile, because a slipping of the floor mat for an automobile can be prevented. When the foam layer is used as the reverse side layer of the present floor mat for an automobile, the foam layer preferably possesses a concave-convex structure on an exposed surface (reverse side) so that a slipping of the floor mat for an automobile can be more effectively prevented.

The term “reverse side layer” as used herein means a layer directly in contact with a carpet floor of an automobile.

The floor mat for an automobile according to the present invention contains one or more mixture layers containing two or more materials including at least one material other than one or more materials forming a porous material layer adjacent to the mixture layer. The term “a material other than one or more materials forming a porous material layer adjacent to the mixture layer” means that (i) when the mixture layer is brought into contact with two porous material layers on both surfaces of the mixture layer (i.e., there are two adjacent porous material layers), a material other than one or more materials forming one of the two porous material layers, and (ii) when the mixture layer is brought into contact with only one porous material layer on a surface thereof (i.e., there is an adjacent porous material layer), a material other than one or more materials forming the porous material layer.

For example, when there is an adjacent porous material layer (for example, the adjacent porous material layer is composed of material A), the mixture layer may be composed of (a) the material A and one or more other materials, or (b) two or more materials other than the material A. When there are two adjacent porous material layers (for example, one adjacent porous material layer is composed of material A and the other is composed of material B), the mixture layer therebetween may be composed of (a) the materials A and B, (b) the material A and one or more materials other than the materials A and B, (c) the material B and one or more materials other than the materials A and B, or (d) two or more materials other than the materials A and B.

The floor mat for an automobile according to the present invention consists essentially of two or more porous material layers as above, and thus exhibits an excellent sound absorbing property. As apparent from the fact that the mixture layer exhibits permeability, the mixture layer is an embodiment of the porous material layer. Because the mixture layer mainly contributes to a sound insulating property, the floor mat for an automobile according to the present invention needs one or more porous material layers, which contribute to a sound absorbing property, and thus consists essentially of two or more layers. When the floor mat contains two or more porous material layers other than the carpet layer, a sufficient space between the upper surface layer and the mixture layer can be obtained. Such a structure is preferable, because an excellent sound absorbing property can be obtained at the upper surface side with respect to the mixture layer, and an excellent sound insulating property can be obtained at the reverse side with respect to the mixture layer, and thus both properties can be obtained. The effects can be obtained by, for example, locating the mixture layer between the porous material layers other than the carpet layer or locating the mixture layer as the reverse side layer.

The floor mat for an automobile according to the present invention contains at least one of the mixture layer having a permeability of 0.1 to 10 mL/cm²/sec, and thus exhibits an excellent sound insulating property, in addition to the above excellent sound absorbing property. When the permeability of the mixture layer is less than 0.1 mL/cm²/sec, the sound absorbing property is liable to be decreased because of the reflection of sound. When the permeability of the mixture layer is more than 10 mL/cm²/sec, the sound insulating property is liable to be decreased because sound cannot be reflected. The permeability is preferably 0.1 to 7 mL/cm²/sec, more preferably 0.1 to 5 mL/cm²/sec, most preferably 0.1 to 4 mL/cm²/sec.

The term “permeability of the mixture layer” as used herein means a value obtained by sampling the mixture layer from a floor mat for an auotomobile and measuring it by a Frazier method defined in JIS L 1096. In this connection, when the mixture layer contains one or more materials forming a porous material layer adjacent to the mixture layer, it is sometimes difficult to sample only the mixture layer, because the mixture layer contains the material forming the adjacent porous material layer. In such a case, the value obtained by sampling the mixture layer and the adjacent porous material layer as a single layer and measuring the permeability of the single layer is regarded as the “permeability of the mixture layer”. The mixture layer containing the material forming the adjacent porous material layer contains one or more materials (i.e., the second material) other than the material forming the adjacent porous material layer, and thus a pressure loss in the mixture layer strongly affects the permeability of the single layer.

The floor mat for an automobile according to the present invention may contain one mixture layer, or two or more mixture layers. When two or more mixture layers are contained, it is preferable to locate the mixture layers in order of each permeability thereof, i.e., to locate a mixture layer having a higher permeability at the upper surface side of the floor mat and a mixture layer having a lower permeability at the reverse surface side thereof. In such a structure, the sound absorbing property is not decreased. In addition, the mixture layer may be located as any layer in the floor mat, such as a reverse side layer, an intermediate layer between the porous material layers, or the like.

The mixture layer is composed of two or more materials including one or more materials other than a material forming the adjacent porous material layer, and thus it is easy to prepare the mixture layer having the above particular permeability. The mixture layer may contain a material forming the adjacent porous material layer, or not contain the same, but it is preferable to contain the material forming the adjacent porous material layer. This is because, when the material forming the adjacent porous material layer is contained, the adhesiveness between the mixture layer and the adjacent porous material layer is excellent and thus a peeling from each other rarely occurs.

As the material other than a material forming the adjacent porous material layer, there may be mentioned, for example, a carpet the same as the porous material which may form the porous material layer, a nonwoven fabric (for example, a fine-fibers nonwoven fabric, a bulky-nonwoven fabric layer, a fused nonwoven fabric, an entangled nonwoven fabric obtained by a water jet, a spun-bonded nonwoven fabric, a melt-blown nonwoven fabric, or a reclaimed fiber felt, a woven fabric (for example, a woven fabric such as a flat weave fabric or twill fabric formed by split yarn and/or tape yarn), a knitted fabric, a foam, a breathable or permeable film, a microporous film, a crushed rubber laminate prepared by laminating crushed rubbers and adhering them by an adhesive, fibers (fibers the same as that forming the fiber layer), or a foamed resin or a point sealed solid resin.

The mixture layer is composed of two or more materials as above. Preferred combinations are as follows:

(1) a combination of an article composed of fibers [for example, a carpet, a nonwoven fabric (such as a fine-fibers nonwoven fabric, a bulky-nonwoven fabric layer, a fused nonwoven fabric, an entangled nonwoven fabric obtained by a water jet, a spun-bonded nonwoven fabric, a melt-blown nonwoven fabric, or a reclaimed fiber felt, a woven fabric (for example, a woven fabric such as a flat weave fabric or twill fabric formed by split yarn and/or tape yarn), a knitted fabric, or the like] and a resin, and

(2) a combination of two or more different kinds of resins. It is more preferable that the mixture layer is composed of one or more foamed resins and one or more materials (particularly fibers or an article composed of fibers) forming the porous material layer adjacent to the mixture layer. This is because it is easy to prepare the mixture layer having the above particular permeability, and adhesiveness between the mixture layer and the adjacent porous material layer is excellent, and thus a peeling from each other rarely occurs.

As resins which may form the mixture layer, there may be mentioned, for example, an isobutylene-maleic anhydride copolymer, acrylonitrile-styrene-acrylic rubber copolymer, acrylonitrile-ethylene-styrene copolymer, acrylic resin, acrylonitrile-styrene copolymer, acrylonitrile-butadiene-styrene copolymer, styrene-butadiene copolymer, ethylene-vinyl acetate copolymer, ethylene-vinyl chloride-vinyl acetate copolymer, epoxy resin, xylene resin, phenol resin, polyimide resin, polyurethane resin, melamine resin, urea resin, styrene-butadiene rubber, butadiene rubber, isoprene rubber, nitrile-butadiene rubber, butyl rubber, ethylene-propylene rubber, ethylene-propylene dinene rubber, urethane rubber, silicone rubber, nitrile rubber, or natural rubber.

The mixture layer may be formed by, for example, applying an adhesive (such as an emulsion or dispersion adhesive, a solvent adhesive, or a hot-melt adhesive) between porous material layers, and then impregnating the adhesive into at least one of the porous material layers. The mixture layer having the above particular permeability may be obtained by appropriately selecting, for example, an amount of adhesive, a pressure applied, viscosity of the adhesive, compatibility between the adhesive and porous material layer, impregnation by a capillary action of the porous material layer, or the like.

When the adjacent porous material layer is a foam layer, the mixture layer and the foam layer can be obtained at the same time by, for example, coating a foamed latex on the porous material layer, and then impregnating a part of the foamed resin into the porous material layer. In this connection, the mixture layer having the above particular permeability may be obtained by appropriately selecting, for example, a pressure applied, viscosity of the foamed latex, an interval between the coating and the press, or the like.

In the floor mat for an automobile according to the present invention, it is preferable that a distance between a surface at the reverse side of the mixture layer and a surface of the reverse side of the floor mat is 0 to ⅔ (more preferably 0 to ½) of a thickness of the floor mat excluding the carpet layer. This preferred embodiment can effectively absorb sounds in an automobile by effectively utilizing the sound absorbing property of the porous material layer located at the upper surface side with respect to the mixture layer, and can effectively insulate sounds from the outside of the automobile by utilizing the reverse side of the mixture layer.

In this connection, when the floor mat has a concave-convex structure such as projected portions at an exposed surface of the reverse side thereof, a flat surface excluding the convex portion (i.e., the concave portion) is regarded as the surface at the reverse side of the floor mat. Further the term “thickness of the floor mat excluding the carpet layer” as used herein means a thickness from the surface at the reverse side of the floor mat to a primary substrate of the carpet (the surface at the reverse side of the primary substrate), measured by applying a load of 50 g/cm² on the floor mat for an automobile having a vertical section formed by cutting the floor mat vertically with respect to the upper surface thereof, and after ten seconds, observing the vertical section from the direction parallel with the upper surface of the floor mat.

The floor mat wherein the distance between the reverse side surface of the mixture layer and the reverse side surface of the floor mat is 0 to ⅔ may be manufactured, for example, by laminating two or more porous material layers (except for the carpet layer), applying a resin between the porous material layers, and impregnating a part or the whole of the applied resin into the porous material layer to form the mixture layer, or alternatively, by applying a resin on the surface at the reverse side of the porous material layer (except for the carpet layer) and impregnating a part or the whole of the applied resin into the porous material layer to form the mixture layer.

In the floor mat for an automobile according to the present invention, the mixture layer having the above particular permeability mainly contributes to the sound insulating property, and thus it is preferable that the floor mat further contains a porous material layer (except for the carpet layer) having a permeability (measured by a Frazier method defined in JIS L 1096) of 15 mL/cm²/sec or more at the upper surface layer with respect to the mixture layer, because the porous material layer can effectively absorb sounds in an automobile. The permeability of the porous material layer is preferably 20 mL/cm²/sec or more, more preferably 25 mL/cm²/sec or more, but the upper limit is not particularly limited.

Preferred combinations of plural porous material layers in the floor mat for an automobile according to the present invention are as follows (the following order is from the upper surface layer to the reverse side layer):

(1) the carpet layer—the mixture layer of the pile and the foamed resin—the foam layer—the mixture layer of the material forming the fibers layer and the foamed resin—the fibers layer (such as the nonwoven fabric layer),

(2) the carpet layer—the mixture layer of the pile and the foamed resin—the foam layer—the mixture layer of the fiber sheet and the foamed resin—the foam layer,

(3) the carpet layer—the mixture layer of the pile and the foamed resin—the foam layer—the mixture layer of the material forming the fibers layer and the foamed resin—the fibers layer—the mixture layer of the material forming the fibers layer and the foamed resin—the foam layer,

(4) the carpet layer—the mixture layer of the pile and the foamed resin—the foam layer—the mixture layer of two kinds of the foamed resins—the foam layer,

(5) the carpet layer—the mixture layer of the pile, the adhesive resin, and the material forming the fibers layer—the fibers layer—the mixture layer of the fibers layer and the adhesive resin—the fibers layer,

(6) the carpet layer—the mixture layer of the pile and the foamed resin—the foam layer—the mixture layer of the material forming the fibers layer and the foamed resin,

(7) the carpet layer—the mixture layer of the pile and the foamed resin—the foam layer—the mixture layer of the fibers layer and the foamed resin,

(8) the carpet layer—the mixture layer of the pile and the foamed resin—the foam layer—the mixture layer of the material forming the fibers layer and the foamed resin—the fibers layer—the mixture layer of the material forming the fibers layer and the foamed resin,

(9) the carpet layer—the mixture layer of the pile and the foamed resin—the foam layer—the mixture layer of two kinds of the foamed resins, and

(10) the carpet layer—the mixture layer of the pile, the adhesive resin, and the material forming the fibers layer—the fibers layer—the mixture layer of the fibers layer and the adhesive resin.

When the permeability (measured by a Frazier method defined in JIS L 1096) of the whole floor mat for an automobile of the present invention is 0.1 mL/cm²/sec or more, an excellent sound absorbing property is obtained with an interaction of the carpet floor. Further, when functional fibers such as deodorant fibers, antimicrobial fibers, or fungicidal fibers, or functional resins such as deodorant resins, perfuming resins, antimicrobial resins, or fungicidal resins are contained in the floor mat for an automobile according to the present invention, their functions can be effectively exhibited. The permeability of the whole floor mat for an automobile according to the present invention is highly dependent on the permeability of the mixture layer, and thus is preferably 0.1 to 7 mL/cm²/sec, more preferably 0.1 to 5 mL/cm²/sec, most preferably 0.1 to 4 mL/cm²/sec.

When an exposed surface of the reverse side layer has a concave-convex structure, the convex portions can bite into the carpet floor of the automobile to enhance a slip resistance of the floor mat.

The floor mat for an automobile according to the present invention is composed of the porous material layers. Therefore, the present floor mat is lightweight, in comparison with a conventional floor mat comprising a rubber, a thermoplastic elastomer or the like. More particularly, a total mass per unit area of the porous material layers other than the carpet layer in the present floor mat for an automobile ranges from about 400 to about 1350 g/m², whereas the total mass per unit area of the layers other than the carpet layer in the conventional floor mat comprising a rubber, a thermoplastic elastomer or the like ranges from about 1700 to about 2400 g/m².

A process for producing the floor mat for an automobile according to the present invention is not particularly limited, but the present floor mat may be produced by, for example, preparing porous materials necessary for forming the porous material layers, and then,

(1) inserting a fusible porous sheet (such as a nonwoven fabric or a net) which can be fused at a temperature not affecting the properties of the porous material, between each of the porous material, heating the fusible porous sheet to a fusing temperature thereof, and impregnating the melted fusible porous sheet into at least one of the porous material to form the mixture layer, and at the same time, integrate the porous materials,

(2) applying a melted hot-melt resin between each of the porous material layers, applying a pressure, and impregnating the melted hot-melt resin into at least one of the porous material to form the mixture layer, and at the same time, integrate the porous materials,

(3) fusing a fusible resin constituting one or more porous material, and impregnating the melted fusible resin into at least one of the porous material to form the mixture layer, and at the same time, integrate the porous materials,

(4) applying an adhesive such as an aqueous adhesive or solvent adhesive between each of the porous material, and impregnating the adhesive into at least one of the porous material to form the mixture layer, and at the same time, integrate the porous materials, or

(5) when a foam layer is contained as the porous material layer, coating a foamed latex on the porous material, and impregnating a part of the foamed latex into the porous material to form the mixture layer, and at the same time, form the foam layer. In this connection, the mixture layer having a permeability of 0.1 to 10 mL/cm²/sec may be obtained by appropriately selecting, for example, a fusing temperature, a pressure applied, an amount of adhesive, viscosity of the adhesive, compatibility between the adhesive and porous material, impregnation by a capillary action of the porous material layer, or the like.

Instead of forming the mixture layer when integrating the porous materials as above, the floor mat for an automobile according to the present invention may be prepared by, for example, preparing a mixture material previously obtained by applying another material to a porous material, and integrating the mixture material and the porous materials. More particularly, the present floor mat may be prepared, for example, by immersing an article composed of fibers (such as a nonwoven fabric or woven fabric) in a foamed resin to form a mixture material composed of the fibers article and the foamed resin, and then by using the resulting mixture material as the porous material to integrate the porous materials, or alternatively, by laminating the resulting mixture material and one or more other porous materials and integrate the porous materials by sewing.

When the peripheral portion of the present floor mat for an automobile is unsightly, or when the present floor mat for an automobile contains a fibers layer and thus the fibers may drop out of the floor mat, it is preferable that the peripheral portion is covered with threads by a serging process, or by a taping process, or the peripheral portion is heat-fused, or covered with the resin.

The floor mat for an automobile according to the present invention will be further explained hereinafter, referring to FIG. 12 which is a schematic sectional view of an embodiment of the present invention.

The floor mat 40 as shown in FIG. 12 contains, in the sequence of from the upper surface layer to the reverse side layer of the floor mat, a carpet layer 41, a first mixture layer 42 composed of pile and a foam, a first foam layer 43, a second mixture layer 44 composed of a nonwoven fabric and a foam, and a second foam layer 45.

The carpet layer 41 is composed of a pile layer 41a and a primary substrate layer 41b. The first foam layer 43 is formed by coating a foam on the carpet layer 41. In this connection, when the foamed resin forming the first foam layer 43 is coated on the carpet, a part of the foamed resin is impregnated into the pile to form the first mixture layer 42. The second mixture layer 44 is formed by coating the foam resin forming the first foam layer 43, and laminating a nonwoven fabric before drying to impregnate a part of the foam resin into the nonwoven fabric, and by coating the foam resin forming the second foam layer 45 on the nonwoven fabric to impregnate a part of the foam resin into the nonwoven fabric. As a result, three kinds of materials, i.e., the nonwoven fabric, the foam forming the first foam layer 43, and the foam forming the second foam layer 45 are mixed in the second mixture layer 44. In the second mixture layer 44, the foam is impregnated into the nonwoven fabric as above, and thus the adhesiveness between the first foam layer 43 and the second mixture layer 44, and between the second mixture layer 44 and the second foam layer 45, is excellent and a peeling between each layers rarely occurs.

The second foam layer 45 is formed by coating the foam on the nonwoven fabric as above, and a concave-convex structure is formed on the exposed surface by embossing the foam before or after drying. The concave-convex structure can enhance a slip resistance of the floor mat 40 for an automobile.

The surface S at the reverse side of the second mixture layer 44 is located at the range between the “surface R at the reverse side of the floor mat” and the “position ⅔ of the thickness D (i.e., a thickness of the floor mat excluding the carpet layer) apart from the surface R”, and the permeability of the first foam layer 43 is 15 mL/cm²/sec or more. Therefore, the floor mat 40 can insulate sounds at the reverse side of the second mixture layer 44, and exhibits an excellent sound absorbing property by the porous material layers (particularly the first foam layer 43) located at the upper surface side with respect to the second mixture layer 44. Further, The floor mat 40 has an excellent decorative function, because it contains the carpet layer 41. In addition, the floor mat 40 has a cushioning property provided by the first foam layer 43 and the second foam layer 45. Further, the first foam layer 43 can relieve an influence of the concave-convex structure of the pile at the primary substrate 41b side of the carpet so that the carpet can be tightly adhered to the second mixture layer 44. Therefore, a peeling between the carpet layer 41 and the second mixture layer 44 rarely occurs.

As mentioned, the floor mat for an automobile according to the present invention is laid over a carpet floor in an automobile. When the carpet floor on which the present floor mat is laid in the automobile has a sound absorbing property, an excellent absorbing function is obtained with an interaction of the carpet floor. For example, the floor mat according to the present invention may be preferably laid over a carpet floor as disclosed in WO98/18657, that is, a carpet floor comprising a porous cushioning layer having a concave-convex structure capable of partially forming an air layer, a lightweight rigid layer containing micropores and having a total resistance of 500 to 2500 Nsm⁻³ to air, a mass per unit area of 300 to 2000 g/m², and rigidity of 0.005 to 10.5 Nm, and a carpet layer, and located so that the concave-convex structure of the cushioning layer is brought into direct contact with the automobile body. An excellent sound-absorbing automobile can be provided by the above combination.

The floor mat for an automobile of the present invention exhibits both an excellent sound insulation property and an excellent sound absorption property.

### EXAMPLES

The present invention will now be further illustrated by, but is by no means limited to, the following Examples.

### Example 1

A tufted carpet composed of a pile layer (area density=600 g/m²) of nylon fibers, and a primary substrate layer (area density=100 g/m²) supporting the pile layer. The substrate layer was a spun-bonded nonwoven fabric of polyester fibers. On the reverse side of the primary substrate layer, a latex mainly composed of a styrene-butadiene copolymer was coated in an amount of 270 g/m² (dry weight).

Then, a mechanically expanded latex of a styrene-butadiene copolymer was coated on the reverse side of the resulting tufted carpet so that an area density of the foam layer produced from the latex became 500 g/m² (dry weight), and dried to integrate the tufted carpet and the styrene-butadiene foam (open-cell structure; foaming magnification=7 fold; thickness=5 mm; apparent density=0.1 g/cm³)

A spun-bonded nonwoven fabric composed of long dividable fibers was treated with a water jet. The long dividable fiber had an orange-like cross-sectional shape as shown in FIG. 1, was composed of 6 nylon components and polyethylene terephthalate components, and was dividable into 16 fibers. As a result of the hydro-entanglement, a hydro-entangled nonwoven fabric (area density=100 g/m²; ratio of fine fibers=100%; thickness=0.4 mm; apparent density=0.25 g/cm³) composed of 6 nylon long fine fibers (fiber diameter=3 μm; cross-sectional shape of fiber generally triangle) and polyethylene terephthalate long fine fibers (fiber diameter=3 μm; cross-sectional shape of fiber=generally a triangle) was prepared.

Then, the resulting hydro-entangled nonwoven fabric was impregnated with a fluoride water-repellant (dry mass=5 g/m²).

Further, a polyamide based hot-melt web [melting point=126 ° C. (DSC method); area density=25 g/m²] was prepared.

Subsequently, the tufted carpet, the styrene-butadiene copolymer foam, the polyamide based hot-melt web, and the hydro-entangled nonwoven fabric composed of long fine fibers impregnated with a water-repellant were laminated in the sequence of from the upper surface layer to the reverse side layer, and the laminate was heated at 140° C. under the linear pressure of 0.6 N/cm to fuse the polyamide based hot-melt web, integrate all of the layers, and thereby obtain the floor mat for an automobile according to the present invention having a structure as shown in FIG. 6.

### Example 2

The procedures mentioned in Example 1 were repeated, except that a wet-laid and hydro-entangled nonwoven fabric (area density=75 g/m²; ratio of fine fibers=80%; thickness=0.2 mm; apparent density=0.38 g/cm³) composed of polypropylene short fine fibers (fiber diameter=3 μm; cross-sectional shape of fiber=generally a triangle) and high-density polyethylene short fine fibers (fiber diameter=3 μm; cross-sectional shape of fiber=generally a triangle) was used instead of the hydro-entangled nonwoven fabric composed of long fine fibers impregnated with a water-repellant, to thereby obtain the floor mat for an automobile according to the present invention having a structure as shown in FIG. 6. The wet-laid and hydro-entangled nonwoven fabric used was prepared by hydro-entangling a wet-laid fiber web composed of short dividable fibers having an orange-like cross-sectional shape as shown in FIG. 1, composed of polypropylene components and high-density polyethylene components, and dividable into 16 fibers (fiber length=10 mm).

### Example 3

The procedures mentioned in Example 1 were repeated to prepare the tufted carpet integrated with the styrene-butadiene copolymer foam, the polyamide based hot-melt web, and the hydro-entangled nonwoven fabric composed of long fine fibers impregnated with a water-repellant.

Then, a mechanically expanded latex of a styrene-butadiene copolymer was coated on one side of the hydro-entangled nonwoven fabric so that an area density of the foam layer produced from the latex became 300 g/m² (dry weight), and dried to integrate the hydro-entangled nonwoven fabric and the styrene-butadiene foam (open-cell structure; foaming magnification=7 fold; thickness of convex portions=2.5 mm; apparent density=0.12 g/cm³). During the drying process, a concave-convex structure having a lattice-like shape or waffle-like shape was produced by embossing the styrene-butadiene foam.

Subsequently, the tufted carpet, the styrene-butadiene copolymer foam, the polyamide based hot-melt web, the hydro-entangled nonwoven fabric composed of long fine fibers impregnated with a water-repellant, and the styrene-butadiene copolymer foam were laminated in the sequence of from the upper surface layer to the reverse side layer, and the laminate was heated at 140° C. under the linear pressure of 0.6 N/cm to fuse the polyamide based hot-melt web, integrate all of the layers, and thereby obtain the floor mat for an automobile according to the present invention having a structure as shown in FIG. 7.

### Example 4

The procedures mentioned in Example 1 were repeated to prepare the tufted carpet integrated with the styrene-butadiene copolymer foam, the polyamide based hot-melt web, and the hydro-entangled nonwoven fabric composed of long fine fibers impregnated with a water-repellant.

Then, dots of a paste containing acrylonitrile-ethylene-styrene copolymer (a slip resistance value=1.2 N) were coated in a hound's tooth check pattern so that dots were placed on intersecting points thereof, on one side of the hydro-entangled nonwoven fabric composed of long fine fibers impregnated with a water-repellant, by a galvanized cylinder (shape of opening=circle; diameter of opening=1.2 mm; ratio of openings=30%), and dried (dry weight=25 g/m²).

Subsequently, the tufted carpet, the styrene-butadiene copolymer foam, the polyamide based hot-melt web, and the hydro-entangled nonwoven fabric having acrylonitrile-ethylene-styrene copolymer dots on the reverse side were laminated in the sequence of from the upper surface layer to the reverse side layer, and the laminate was heated at 140° C. under the linear pressure of 0.6 N/cm to fuse the polyamide based hot-melt web, and integrate all of the layers, and thereby obtain the slip-proof floor mat for an automobile according to the present invention having a structure as shown in FIG. 8.

### Example 5

The procedures mentioned in Example 3 were repeated, except that a tufted carpet composed of a pile layer (area density=600 g/m²) of nylon fibers, and a primary substrate layer (area density=120 g/m²) supporting the pile layer was used instead of the tufted carpet in Example 3, to thereby obtain the floor mat for an automobile according to the present invention having a structure as shown in FIG. 7. The substrate layer in the tufted carpet used was a woven fabric of polypropylene fibers, and on the reverse side of the primary substrate layer, a latex mainly composed of a styrene-butadiene copolymer was coated in an amount of 270 g/m² (dry weight).

### Example 6

A tufted carpet composed of a pile layer (area density=1200 g/m²) of polypropylene fibers, and a primary substrate layer (area density=250 g/m²) supporting the pile layer. The substrate layer was a spun-bonded nonwoven fabric of polyester fibers. On the reverse side of the primary substrate layer, a latex containing a styrene-butadiene copolymer as a main component and a fluoride water-repellent was coated in an amount of 250 g/m² (dry weight).

Further, a bulky nonwoven fabric (area density=70 g/m²; thickness=2 mm; apparent density=0.035 g/cm³) was prepared by entangling a fiber web composed of 100% of polyethylene terephthalate fibers (6.6 dtex) by a needle punching.

Then, a mechanically expanded latex of a styrene-butadiene copolymer was coated on the reverse side of the resulting tufted carpet so that an area density of the foam layer produced from the latex became 1000 g/m² (dry weight), and dried after laminating the bulky nonwoven fabric, to thereby integrate the tufted carpet, the foam layer (open-cell structure; foaming magnification=2.5 fold; thickness=4 mm; apparent density=0.25 g/cm³), and the bulky nonwoven fabric and obtain a tri-layered sheet.

Subsequently, a mechanically expanded latex of a styrene-butadiene copolymer was coated on the surface of the bulky nonwoven fabric so that an area density of the foam layer produced from the latex became 500 g/m² (dry weight), and dried to integrate the tri-layered sheet and the styrene-butadiene copolymer foam (open-cell structure; foaming magnification=3 fold; thickness in convex portions=1 mm; apparent density=0.5 g/cm³), and obtain the floor mat for an automobile according to the present invention. During the drying process, a concave-convex structure having a lattice-like shape or waffle-like shape was produced by embossing the styrene-butadiene foam.

### Comparative Example 1

The tufted carpet as used in Example 1 and a styrene-butadiene rubber sheet (area density=1.40 kg/m²) were prepared.

The tufted carpet and the styrene-butadiene rubber sheet were laminated so that the primary substrate was brought into contact with the styrene-butadiene rubber sheet, and then a press plate having channels for forming nibs was used to integrate the laminate, form nibs, and carry out vulcanization to obtain the comparative floor mat for an automobile having a structure as shown in FIG. 9.

### Comparative Example 2

The tufted carpet as used in Example 1 was prepared.

Then, on the primary substrate of the tufted carpet, a melt-extruded styrene-butadiene copolymer elastomer was laminated. A roll having channels for forming nibs was used to integrate the tufted carpet and the styrene-butadiene copolymer elastomer and form nibs to obtain the comparative floor mat for an automobile having a structure as shown in FIG. 9.

### Comparative Example 3

The tufted carpet integrated with the styrene-butadiene copolymer foam (foam A) as used in Example 1 was prepared.

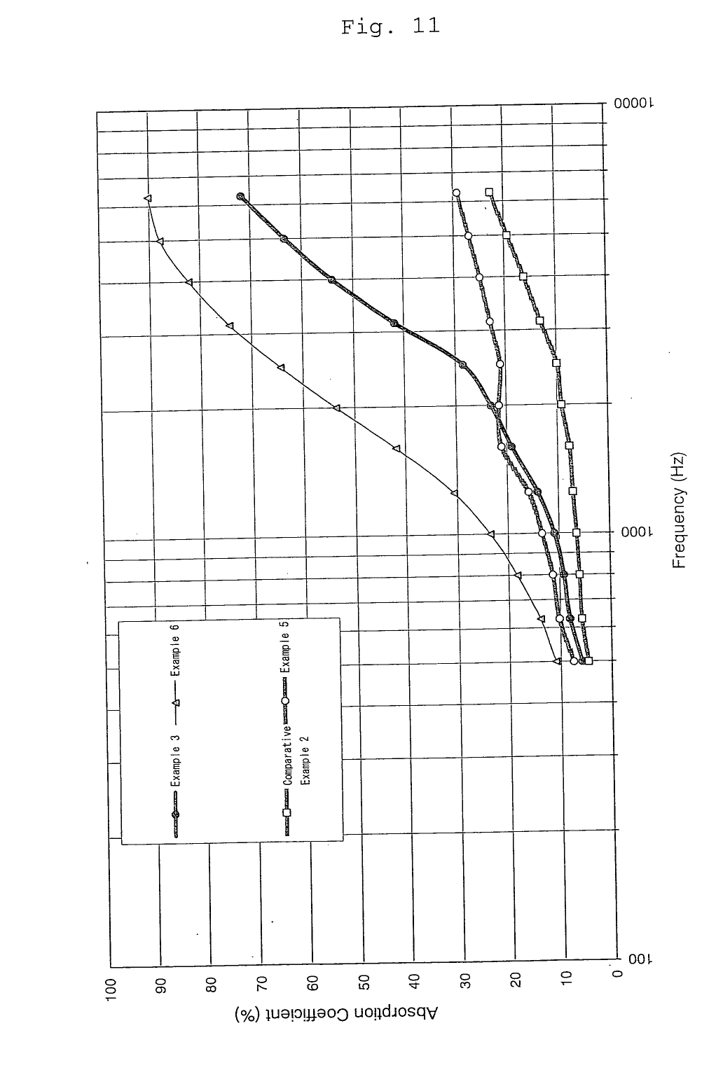

Then, a mechanically expanded latex of a styrene-butadiene copolymer was coated on a surface of the styrene-butadiene copolymer foam (foam A) so that an area density of the foam layer produced from the latex became 300 g/m² (dry weight), and dried to integrate the styrene-butadiene copolymer foam (foam A) and the styrene-butadiene copolymer foam (foam B; open-cell structure; foaming magnification=7 fold; thickness=2.5 mm; apparent density=0.12 g/cm³) to obtain the comparative floor mat for an automobile having a structure as shown in FIG. 10. During the drying process, a concave-convex structure having a lattice-like shape or waffle-like shape was produced by embossing the the styrene-butadiene copolymer foam (foam B).

### Comparative Example 4

A bulky nonwoven fabric (area density=400 g/m²; thickness=5 mm; apparent density=0.08 g/cm³) was prepared by entangling a fiber web composed of 100% polyethylene terephthalate fibers (6.6 dtex) by a needle punching. Then, the bulky nonwoven fabric was impregnated with a fluoride water-repellant (dry mass=5g/m²).

Further, the tufted carpet and the polyamide based hot-melt web as used in Example 1 were prepared.

Subsequently, the tufted carpet, the polyamide based hot-melt web, and the bulky nonwoven fabric impregnated with a water-repellant were laminated in the sequence of from the upper surface layer to the reverse side layer, and the laminate was heated at 140° C. under the linear pressure of 0.6 N/cm to fuse the polyamide based hot-melt web, integrate all of the layers, and thereby obtain the comparative floor mat for an automobile.

Evaluation of Properties

(1) Determination of a Water-Resistant Pressure

A water-resistant pressure of each of the floor mats for an automobile prepared in Examples 1 to 6 and Comparative Examples 1 to 4 was determined in accordance with the above-mentioned method. The results are shown in Table 1.

(2) Evaluation of Property of Preventing Staining

A sample (50 cm×50 cm) was prepared by cutting each of the floor mats for an automobile prepared in Examples 1 to 6 and Comparative Examples 1 to 4. Then, the sample was laid on a carpet floor and 200 mL of water colored with ink was dropped on the center of the sample. After 48 hours, a stained condition was evaluated. The results are shown in Table 1. The evaluation was carried out in accordance with the following two ratings:

X . . . The colored water reached the carpet floor and the carpet floor was stained

O . . . The colored water did not reach the carpet floor and the carpet floor was not stained

It is assumed from the results of “(1) Determination of a water-resistant pressure” and “(2) Evaluation of property for preventing staining” that a floor mat having a water-resistant pressure of 40 mmH₂O or more can prevent rainwater, muddy water, spilled drinks or the like from reaching and staining the carpet floor.

(3) Determination of Permeability

A permeability of each of the whole floor mats for an automobile prepared in Examples 1 to 6 and Comparative Examples 1 to 4, and each of the carpet layers alone therein, was determined in accordance with the above-mentioned method. The results are shown in Table 1. Further, a permeability of each of the foam layers as the reverse side layers alone in the floor mat for an automobile prepared in Examples 3, 5 and 6 and Comparative Example 3 was determined. The results are shown in Table 2.

TABLE 1

| | | Water- | | Permeability |
|---|---|---|---|---|
| | Permeability of | resistant | Property of | of carpet |
| | floor mat | pressure | preventing | layer |
| | (mL/cm²/sec) | (mmH₂O) | staining | (mL/cm²/sec) |
| Example 1 | 5.5 | 310 | ◯ | 7.3 |
| Example 2 | 4 | 85 | ◯ | 7.3 |
| Example 3 | 3.3 | 380 | ◯ | 7.3 |
| Example 4 | 5.3 | 320 | ◯ | 7.3 |
| Comparative | 0 | 2,000< | ◯ | 7.3 |
| Example 1 | | | | |
| Comparative | 0 | 2,000< | ◯ | 7.3 |
| Example 2 | | | | |
| Comparative | 48.5 | 0 | X | 7.3 |
| Example 3 | | | | |
| Example 5 | 0.3 | 400 | ◯ | 0.5 |
| Comparative | 10.5 | 10 | X | 7.3 |
| Example 4 | | | | |
| Example 6 | 4.8 | 150 | ◯ | 55 |

TABLE 2

| | Permeability of reverse |
|---|---|
| | foam layer |
| | (mL/cm²/sec) |
| Example 3 | 3.4 |
| Comparative | |
| Example 3 | 3.4 |
| Example 5 | 3.4 |
| Example 6 | 5.0 |

(4) Evaluation of Sound Absorbing Property

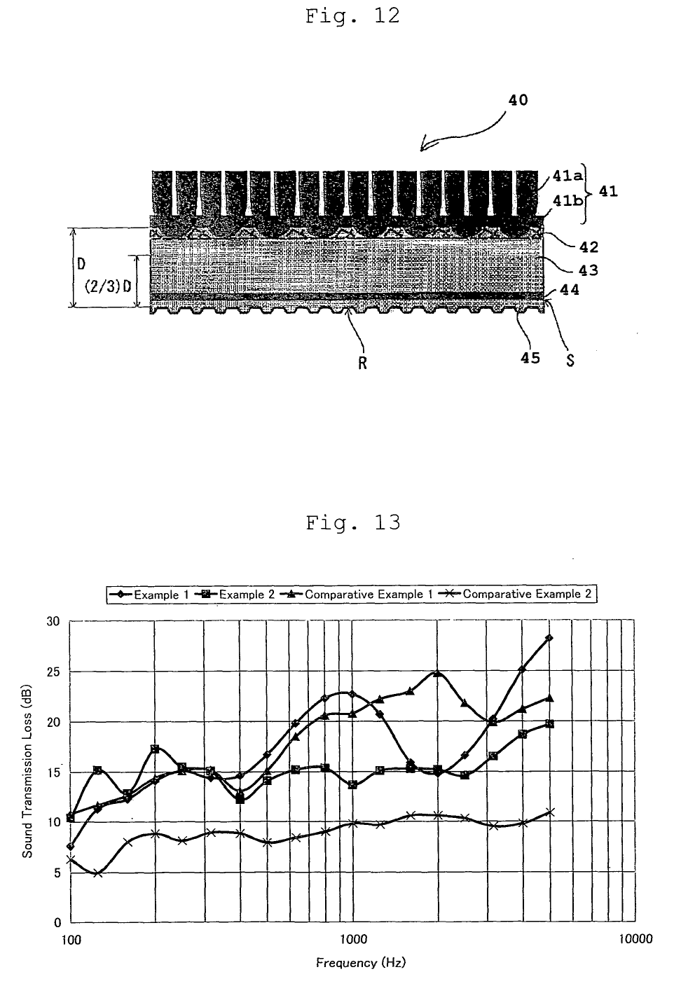

A sound absorbing property was evaluated by a tester Bruel & kjær, in accordance with ISO 10534-2 “Acoustics-Determination of sound absorption coefficient and impedance in impedance tubes, Part 2: Transfer-Function method”. The results are shown in FIG. 11.

It is apparent from the results of Examples 3 and 5 that the floor mat containing the carpet layer alone having a high permeability exhibits a more excellent sound absorbing property. Further, it is apparent from the results of Example 3 and Comparative Example 2 that the whole floor mat for an automobile having a higher permeability exhibits a more excellent sound absorbing property. Still further, it is apparent from the results of Example 3 and 6 that the floor mat for an automobile having a carpet layer with a higher area density exhibits a more excellent sound absorbing property, particular for a treble sound.

As above, the floor mat for an automobile according to the present invention (Examples 1 to 6) has a permeability higher than that of the conventional floor mat (Comparative Examples 1 to 4). Therefore, it is assumed that when a functional substance such as a deodorant or an aromatic is contained, the functions can be effectively exhibited, and when the carpet floor has a sound absorbing property, the present floor mat can exhibit an excellent sound absorbing property utilizing the sound absorbing property of the carpet floor.

### Example 7

A tufted carpet (permeability=55 mL/cm²/sec) was composed of a pile layer (mass per unit area=500 g/m²) of polypropylene fibers, and a primary substrate layer (mass per unit area=120 g/m²) supporting the pile layer. The substrate layer was a spun-bonded nonwoven fabric of polyester fibers. On the reverse side of the primary substrate layer, a latex containing a styrene-butadiene rubber as a main component was coated in an amount of 240 g/m² (dry weight). Further, a long-fibers nonwoven fabric (mass per unit area=25 g/m²; permeability=215 mL/cm²/sec; unisel, manufactured by Teijin Limited) was prepared by a tow opening method.

Then, a styrene-butadiene rubber latex and a natural rubber latex were mixed at a weight ratio of 30:70 and mechanically expanded. The mechanically expanded mixed rubber latex was coated on the reverse side of the resulting tufted carpet so that a mass per unit area (dry weight) became 700 g/m². Before drying the mixed rubber latex, the long-fibers nonwoven fabric and the tufted carpet were laminated so that the mixed rubber latex was impregnated into the long-fibers nonwoven fabric. After 1 minute, the laminate was put into a drier to integrate the tufted carpet, the first mixed rubber foam (open-cell structure; foaming magnification=3 fold; thickness=3 mm; apparent density=0.23 g/cm³), and the long-fibers nonwoven fabric and thereby obtain a precomplex.

Subsequently, the mechanically expanded mixed rubber latex (a styrene-butadiene rubber latex:a natural rubber latex=30:70) was coated on the surface of the long-fibers nonwoven fabric in the resulting precomplex so that a mass per unit area (dry weight) became 540 g/m². After a part of the mixed rubber latex was impregnated into the long-fibers nonwoven fabric, the laminate was dried to integrate the precomplex and the second mixed rubber foam (open-cell structure; foaming magnification=2.5 fold; thickness of convex portions=2 mm; apparent density=0.27 g/cm³) and thereby obtain a floor mat for an automobile. During the drying process, a concave-convex structure having a lattice-like shape or waffle-like shape was produced on the exposed surface by embossing the second mixed rubber foam.

As shown in FIG. 12, the resulting floor mat for an automobile contained the tufted carpet layer, the first mixture layer composed of the pile and the mixed rubber foam, the first mixed rubber foam layer (permeability=57 mL/cm²/sec), the second mixture layer, and the second mixed rubber foam layer (permeability=45 mL/cm²/sec) having the concave-convex structure on the exposed surface, in the sequence of from the upper surface layer to the reverse side layer. The second mixture layer was integrated by impregnating a foam the same as that forming the first and second mixed rubber foam layers into the long-fibers nonwoven fabric. The permeability of the whole floor mat for an automobile was 0.15 mL/cm²/sec. The thickness, permeability, and mass per unit area of the floor mat excluding the tufted carpet layer were 5 mm, 0.2 mL/cm²/sec, and 1265 g/m², respectively. The distance between the surface at the reverse side of the second mixture layer and the reverse side of the floor mat was 2 mm, and the permeability of the second mixture layer was 0.2 mL/cm²/sec. The distance between the surface at the reverse side of the first mixture layer and the reverse side of the floor mat was 5 mm, and the permeability of the first mixture layer was 15 mL/cm²/sec.

### Example 8

The tufted carpet as used in Example 7, and a needle-punched nonwoven fabric (mass per unit area=70 g/m²; thickness=0.4 mm; apparent density=0.18 g/cm³; permeability=400 mL/cm²/sec) composed of 70 mass % of polyester fibers (fineness=7.8 dtex; fiber length=76 mm) and 30 mass % of polyester fibers (fineness=3.3 dtex; fiber length=51 mm) were prepared.

Then, the mechanical expanded mixed rubber latex as used in Example 7 was coated on the reverse side of the tufted carpet so that a mass per unit area (dry weight) became 700 g/m². Before drying the mixed rubber latex, the needle-punched nonwoven fabric and the tufted carpet were laminated so that the mixed rubber latex was impregnated into the needle-punched nonwoven fabric. After 1 minute, the laminate was put into a drier to integrate the tufted carpet, the first mixed rubber foam (open-cell structure; foaming magnification=3 fold; thickness=3 mm; apparent density=0.23 g/cm³), and the needle-punched nonwoven fabric and thereby obtain a precomplex.

Subsequently, the mechanically expanded mixed rubber latex as used in Example 7 was coated on the surface of the needle-punched nonwoven fabric in the resulting precomplex so that a mass per unit area (dry weight) became 540 g/m². After a part of the mixed rubber latex was impregnated into the needle-punched nonwoven fabric, the laminate was dried to integrate the precomplex and the second mixed rubber foam (open-cell structure; foaming magnification=2.5 fold; thickness of convex portions=2 mm; apparent density=0.27 g/cm³) and thereby obtain a floor mat for an automobile. During the drying process, a concave-convex structure having a lattice-like shape or waffle-like shape was produced on the exposed surface by embossing the second mixed rubber foam.

As shown in FIG. 12, the resulting floor mat for an automobile contained the tufted carpet layer, the first mixture layer composed of the pile and the mixed rubber foam, the first mixed rubber foam layer (permeability=57 mL/cm²/sec), the second mixture layer, and the second mixed rubber foam layer (permeability=45 mL/cm²/sec) having the concave-convex structure on the exposed surface, in the sequence of from the upper surface layer to the reverse side layer. The second mixture layer was integrated by impregnating a foam the same as that forming the first and second mixed rubber foam layers into the needle-punched nonwoven fabric. The permeability of the whole floor mat for an automobile was 2.2 mL/cm²/sec. The thickness, permeability, and mass per unit area of the floor mat excluding the tufted carpet layer were 5 mm, 2.8 mL/cm²/sec, and 1265 g/m², respectively. The distance between the surface at the reverse side of the second mixture layer and the reverse side of the floor mat was 2 mm, and the permeability of the second mixture layer was 3.8 mL/cm²/sec. The distance between the surface at the reverse side of the first mixture layer and the reverse side of the floor mat was 5 mm, and the permeability of the first mixture layer was 15 mL/cm²/sec.

### Comparative Example 5

The tufted carpet as used in Example 7 and a styrene-butadiene-styrene elastomer sheet (mass per unit area=1350 g/m²) were prepared.

The tufted carpet and the styrene-butadiene-styrene elastomer sheet were laminated so that the primary substrate of the tufted carpet was brought into contact with the styrene-butadiene-styrene elastomer sheet, and then a press plate having channels for forming nibs was used to integrate the laminate and form nibs by pressing after heating to obtain a floor mat for an automobile (permeability=0 mL/cm²/sec; mass per unit area=2210 g/m²). The resulting floor mat for an automobile contained the tufted carpet layer, the carpet-elastomer mixture layer, and the elastomer layer, in the sequence of from the upper surface layer to the reverse side layer. The permeability of the carpet-elastomer mixture layer was 0 mL/cm²/sec.

### Comparative Example 6

The tufted carpet as used in Example 7 and the needle-punched nonwoven fabric as used in Example 8 were prepared.

The mechanical expanded mixed rubber latex as used in Example 7 was coated on the reverse side of the tufted carpet so that a mass per unit area (dry weight) became 700 g/m². Before drying the mixed rubber latex, the needle-punched nonwoven fabric and the tufted carpet were laminated and immediately put into a drier to integrate the tufted carpet, the first mixed rubber foam (open-cell structure; foaming magnification=3 fold; thickness=3 mm; apparent density=0.23 g/cm³), and the needle-punched nonwoven fabric and thereby obtain a precomplex. A part of the first mixed rubber foam was impregnated into the needle-punched nonwoven fabric. A layer composed of only the needle-punched nonwoven fabric and a mixture layer in which the needle-punched nonwoven fabric and the first mixed rubber foam were integrated was formed.

Then, the mechanically expanded mixed rubber latex as used in Example 7 was coated on the surface of the needle-punched nonwoven fabric in the resulting precomplex so that a mass per unit area (dry weight) became 540 g/m². After a part of the mixed rubber latex was impregnated into the needle-punched nonwoven fabric, the laminate was dried to integrate the precomplex and the second mixed rubber foam (open-cell structure; foaming magnification=2.5 fold; thickness of convex portions=2 mm; apparent density=0.27 g/cm³) and thereby obtain a floor mat for an automobile. During the drying process, a concave-convex structure having a lattice-like shape or waffle-like shape was produced on the exposed surface by embossing the second mixed rubber foam.

As shown in FIG. 12, the resulting floor mat for an automobile contained the tufted carpet layer, the first mixture layer composed of the pile and the mixed rubber foam, the first mixed rubber foam layer (permeability=57 mL/cm²/sec), the second mixture layer, and the second mixed rubber foam layer (permeability=45 mL/cm²/sec) having the concave-convex structure on the exposed surface, in the sequence of from the upper surface layer to the reverse side layer. The second mixture layer was integrated by impregnating a foam the same as that forming the first and second mixed rubber foam layers into the needle-punched nonwoven fabric. The permeability of the whole floor mat for an automobile was 7 mL/cm²/sec. The thickness, permeability, and mass per unit area of the floor mat excluding the tufted carpet layer were 5 mm, 8.3 mL/cm²/sec, and 1265 g/m², respectively. The distance between the surface at the reverse side of the second mixture layer and the reverse side of the floor mat was 2 mm, and the permeability of the second mixture layer was 11.0 mL/cm²/sec. The distance between the surface at the reverse side of the first mixture layer and the reverse side of the floor mat was 5 mm, and the permeability of the first mixture layer was 15 mL/cm²/sec.

Evaluation of Properties

(1) Evaluation of Sound Insulation Property

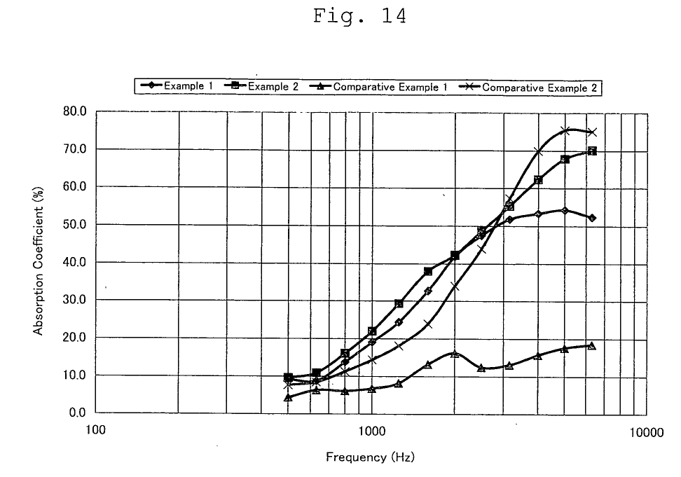

A sound transmission loss of each floor mat for an automobile prepared in Examples 7 and 8 and Comparative Examples 5 and 6 was measured in accordance with JIS A1416 (Acoustics-Method for laboratory measurement of airbone sound insulation of building elements). The results are shown in FIG. 13. It is considered that the difference of 5 dB or more in the sound transmission loss can be distinguished by a human being with normal hearing.

(2) Evaluation of Sound Absorption Property

A sound absorption coefficient of each floor mat for an automobile prepared in Examples 7 and 8 and Comparative Examples 5 and 6 was measured by a tester Brüel & kjær, in accordance with ISO 10534-2 “Acoustics-Determination of sound absorption coefficient and impedance in impedance tubes, Part 2: Transfer-Function method”. The results are shown in FIG. 14.

As apparent from the results in FIGS. 13 and 14, the floor mat for an automobile of the present invention exhibited an excellent sound insulation property and an excellent sound absorption property. On the contrary, the floor mat for an automobile prepared in Comparative Example 5 exhibited an excellent sound insulation property, but a poor sound absorption property. Further, the floor mat for an automobile prepared in Comparative Example 6 exhibited an excellent sound absorption property, but a poor sound insulation property. Furthermore, it was confirmed from the comparison between Example 7 and Comparative Example 5 that an excellent sound absorption property is derived from the mixture layer having a permeability of 0.1 mL/cm²/sec or more. It was also confirmed from the comparison between Example 8 and Comparative Example 6 that an excellent sound insulation property is derived from the mixture layer having a permeability of 10 mL/cm²/sec or less.

As above, the present invention was explained with reference to particular embodiments, but modifications and improvements obvious to those skilled in the art are included in the scope of the present invention.

1. A floor mat for an automobile consisting essentially of one or more porous material layers wherein a water-resistant pressure of a whole floor mat is 40 mmH₂O or more.

2. The floor mat for an automobile according to claim 1, wherein a permeability of the whole floor mat is 0.3 mL/cm²/sec or more.

3. The floor mat for an automobile according to claim 1, wherein the porous material layer as an upper surface layer of the floor mat is a carpet layer.

4. The floor mat for an automobile according to claim 3, wherein a permeability of the carpet upper surface layer alone is 2 mL/cm²/sec or more.

5. The floor mat for an automobile according to claim 1, containing a fine-fibers nonwoven fabric layer comprising fine fibers having a diameter of 10 μm or less, as the porous material layer of an intermediate layer and/or a reverse side layer.

6. The floor mat for an automobile according to claim 5, wherein the fine-fibers nonwoven fabric layer further contains a resin.

7. The floor mat for an automobile according to claim 1, containing a foam layer, as the porous material layer of an intermediate layer and/or a reverse side layer.

8. The floor mat for an automobile according to claim 1, wherein a permeability of the reverse side layer alone is 0.3 to 20 mL/cm²/sec.

9. The floor mat for an automobile according to claim 7, wherein an exposed surface of the foam layer as the reverse side layer has a concave-convex structure.

10. A slip-proof floor mat for an automobile comprising (1) the floor mat according to claim 1 and (2) projected portions of a slip-resistant resin having a slip resistance value of 0.6 N or more, the projected portions being partially located on an exposed surface of a reverse side layer of the floor mat.

11. The slip-proof floor mat for an automobile according to claim 10 wherein a water-resistant pressure of the whole slip-proof floor mat is 40 mmH₂O or more.

12. A floor mat for an automobile consisting essentially of two or more porous material layers, wherein at least one of the porous material layers is a mixture layer containing two or more materials including a material other than one or more materials forming a porous material layer adjacent to the mixture layer, and a permeability of the mixture layer is 0.1 to 10 mL/cm²/sec.

13. The floor mat for an automobile according to claim 12, wherein the porous material layer as an upper surface layer of the floor mat is a carpet layer.

14. The floor mat for an automobile according to claim 13, containing two or more porous material layers other than the carpet layer.

15. The floor mat for an automobile according to claim 14, containing a porous material layer having a permeability of 15 mL/cm²/sec or more between the mixture layer having a permeability of 0.1 to 10 mL/cm²/sec and the carpet layer.

16. The floor mat for an automobile according to claim 13, wherein a distance between a surface at the reverse side of the mixture layer having a permeability of 0.1 to 10 mL/cm²/sec and a surface at the reverse side of the floor mat is 0 to ⅔ of a thickness of the floor mat excluding the carpet layer.

17. The floor mat for an automobile according to claim 12, wherein the materials forming the mixture layer having a permeability of 0.1 to 10 mL/cm²/sec are a foam resin and a material forming a porous material layer adjacent to the mixture layer.
